(19) United States
(12) Patent Application Publication
(10) Pub. No.: US 2023/0088640 A1
(43) Pub. Date: Mar. 23, 2023

(54) A METHOD AND AN APPARATUS FOR MANUFACTURING A POROUS GRAPHENE LAYER ACROSS A PRECURSOR MATERIAL LAYER ON A SUBSTRATE THROUGH THERMALLY LOCALIZED LASER GRAPHITISATION

(71) Applicant: Panasonic Factory Solutions Asia Pacific Pte. Ltd., Singapore (SG)

(72) Inventors: Nicholas Cheng Yang THAM, Singapore (SG); Pankaj Kumar SAHOO, Rochester, NY (US); Vadakke Matham MURUKESHAN, Singapore (SG); Young-Jin KIM, Daejeon (KR); Mun Ji LOW, Singapore (SG)

(21) Appl. No.: 17/798,854

(22) PCT Filed: Jan. 28, 2021
(86) PCT No.: PCT/SG2021/050038

§ 371 Date: Aug. 10, 2022

(30) Foreign Application Priority Data
Mar. 19, 2020 (SG) 10202002566X
Oct. 14, 2020 (SG) 10202010197X

(51) Int. Cl. C01B 32/184; B01J 19/12; H01B 1/04

(52) U.S. Cl. CPC C01B 32/184; B01J 19/128; B01J 19/127; B01J 19/123; H01B 1/04

(57) ABSTRACT

The present disclosure provides a method and an apparatus for manufacturing a porous graphene layer across a precursor material layer on a substrate. The method comprises: determining a first temperature threshold and a second temperature threshold, the first temperature threshold being a minimum temperature required for forming the porous graphene layer from a precursor material layer on a portion of the substrate, the second temperature threshold being one at which the substrate is likely to experience thermal damages above this temperature threshold; determining at least one of operating parameters of a light source, wherein exposing the precursor material layer to the light source that is operating under the at least one of the operating parameters causes a temperature of the portion of the substrate adjoining a side of the precursor material layer to maintain below the second temperature threshold and a temperature of the opposite side of the precursor material layer to rise above the first temperature threshold; and generating an a beam of light from the light source to the precursor material layer based on the at least one of operating parameters of the light source to form the porous graphene layer.

### FIELD OF INVENTION

The present invention relates broadly, but not exclusively, to a method and an apparatus for manufacturing a porous graphene layer across a precursor material layer on a substrate through thermally localized laser graphitisation.

### BACKGROUND

Carbon-based electronics, especially graphene confers excellent properties such as being lightweight, good electronic conductivity and other unique assets for applications in flexible devices or even biodegradable electronics and energy storage. Moreover, in consideration of different kinds of devices based on materials such as cloth, low temperature polymers, materials with low thermal budget/thermally sensitive materials, as a new generation of economical and flexible gadgets for various applications, there is a need to ensure that the electronic components are flexible in order to conform to these new form factors as well as meet tighter processing requirements of these new materials.

One of the most efficient manufacturing approaches to manufacture such flexible electronic components is to use high powered lasers to ‘write’ arbitrarily shaped conductive graphene-like devices onto a flexible precursor material, such as polyimide before transferring to other desired materials or devices. However, these conductive graphene-like layer can be brittle and difficult to transfer, and existing transfer methods not only add an extra processing step but also result in loss of useful properties of the original precursor substrate.

Direct writing of conductive graphene using a light source such as a laser offers a promising solution to these challenges, minimizing the number of processing steps and maintaining the both the electronic performance of a porous graphene layer as well as the useful properties of the precursor material. Moreover, these conductive porous graphene devices can easily be written on a precursor material attached directly to a substrate of various form factors (e.g. flexible, thermally sensitive, stretchable, etc.) where needed and easily removed when the device has reached the end of its life cycle. However, limitations in current writing process result in a susceptibility towards thermally damaging the substrate during the process, in addition to rigid parametric conditions.

There is thus a need to address one or more of the above challenges and develop new method and apparatus for manufacturing a porous graphene layer across a precursor material layer on a substrate. Furthermore, other desirable features and characteristics will become apparent from the subsequent detailed description and the appended claims, taken in conjunction with the accompanying drawings and this background of the disclosure.

### SUMMARY

In a first aspect, the present disclosure provides a method for manufacturing a porous graphene layer across a precursor material on a substrate, the method comprising of: determining a first temperature threshold and a second temperature threshold, the first temperature threshold being a minimum temperature required for forming the porous graphene layer from a precursor material layer on a portion of the substrate, the second temperature threshold being one at which the substrate is likely to experience thermal damages above this temperature threshold; determining at least one of operating parameters of a light source, wherein exposing the precursor material layer to the light source that is operating under the at least one of the operating parameters causes a temperature of the portion of the substrate adjoining a side of the precursor material layer to maintain below the second temperature threshold and a temperature of the opposite side of the precursor material layer to rise above the first temperature threshold; and generating a beam of light from the light source to the precursor material layer based on the at least one of operating parameters of the light source to form the porous graphene layer.

In a second aspect, the present disclosure provides an apparatus for manufacturing a porous graphene layer across a precursor material layer on a substrate, the apparatus comprising: at least one processor; and at least one memory including computer program code; the at least one memory and the computer program code configured to, with at least one processor, cause the apparatus at least to: determine a first temperature threshold and a second temperature threshold, the first temperature threshold being a minimum temperature required for a precursor material layer on a portion of the substrate to form the porous graphene layer, the second temperature threshold being one at which the substrate is likely to experience thermal damages above this temperature threshold; determine at least one of operating parameters of alight source, wherein exposing the precursor material layer to the light source that is operating under the at least one of the operating parameters cause a temperature of the portion of the substrate adjoining a side of the precursor material layer to maintain below the second temperature threshold and a temperature of the opposite side of the precursor layer to rise above the first temperature threshold; and generate a beam of light from the light source to the precursor material layer based on the at least one of operating parameters of the light source to form the porous graphene layer.

In a third aspect, the present disclosure provides an electronic device comprising at least one porous graphene layer across a precursor material layer on a substrate according to the first aspect.

In a fourth aspect, the present disclosure provides afilm comprising a substrate and at least one porous graphene layer across a precursor material layer on the substrate according to the first aspect.

### BRIEF DESCRIPTION OF THE DRAWINGS

The accompanying Figures, where like reference numerals refer to identical or functionally similar elements throughout the separate views and which together with the detailed description below are incorporated in and form part of the specification, serve to illustrate various embodiments and to explain various principles and advantages in accordance with a present embodiment, by way of non-limiting example only.

Embodiments of the invention will be better understood and readily apparent to one of ordinary skill in the art from the following written description, by way of example only, and in conjunction with the drawings, in which:

FIG. 1A depicts schematic diagrams for a process for manufacturing a process for manufacturing a porous graphene layer across a precursor material layer on a substrate according to an embodiment of the present disclosure.

FIG. 1B depicts a schematic diagram illustrating a process for manufacturing a porous graphene layer across a precursor material layer on a substrate using a beam of light according to an embodiment of the present disclosure.

FIG. 1C depicts schematic diagrams illustrating formations of a porous graphene layer under four different temperature conditions at the top surface and the bottom surface of the precursor material respectively when exposed to a beam of light according to various embodiments of the present disclosure.

FIGS. 1D and 1E depict a schematic diagram illustrating an electronic sensor comprising a porous graphene layer formed across a portion of a polyimide (PI) film (precursor material layer) on a thermochromic paper (substrate) before and after peeling off the PI film from the substrate respectively according to an embodiment.

FIGS. 1F and 1G depict a schematic diagram illustrating an electronic sensor comprising a porous graphene layer 186 formed across a portion of a polyimide (PI) film (precursor material layer) on a thermochromic paper (substrate) before and after peeling off the PI film from the substrate respectively according to another embodiment.

FIG. 2 illustrates a temperature profile of a precursor material layer (for example the PI film) in a light induced localized graphitisation process according to an embodiment of the present disclosure.

FIG. 3A depicts a flow chart illustrating a method for manufacturing a porous graphene layer across a precursor material on a substrate according to various embodiments of the present disclosure.

FIG. 3B depicts a flow chart illustrating a determining at least one of operating parameter a light source of generating a femtosecond pulsed laser (light source) for manufacturing porous graphene layer across a polyimide (PI) film (precursor material layer) attached on thermochromic paper (substrate) according to an embodiment.

FIG. 4 depicts an apparatus for manufacturing a porous graphene layer across a precursor material layer on a substrate according to various embodiments of the present disclosure.

FIG. 5 depicts a temperature 3D graph illustrating predicted temperatures at the top and the bottom surfaces of a precursor material upon exposing to a light source generating an intermittent beam of light operated under various fluences and number of pulses at a light pulse repetition rate of 250 kHz and according to an embodiment.

FIG. 6 depicts schematic diagrams illustrating a top view and a cross-section view of two porous graphene layers formed above a flexible substrate for respective applications of a humidity sensor and a microsupercapacitor according to an embodiment.

FIG. 7A depicts a schematic of modelled region in the PI film within which focused femtosecond (fs) pulses induce a temperature distribution T(\vec{r}, t).

FIG. 7B depicts a predicted temperature rise due to a single fs pulse at different F values with temperature rise omitted for clarity. Inset: Schematic of temperature rise (Tᵣᵢₛₑ) due to one pulse and diffusion time (τ_{d}) after peak temperature rise.

FIG. 7C depicts a predicted temperature rise across 5.0 ms due to different N pulses with different repetition rates (f) or periods (τ_{L}) at the same fluence (F=0.034 Jcm⁻²). Inset: Schematic of temperature accumulation (T_{accum}) due to multiple pulses.

FIG. 7D depicts a temperature distribution after irradiation of representative parameters in the localised laser graphitisation (LLG) regime.

FIG. 8A depicts a comparison between predicted LLG regimes (shaded turquoise region) and identified material changes at the top surface of PI tape for 50 kHz, 100 kHz, 250 kHz and 500 kHz across N from 1 to 5,000 and F from 0.023 Jcm⁻² to 0.068 Jcm⁻².

FIG. 8B depicts a comparison between predicted LLG regime and colouration of the thermochromic paper at the bottom surface of PI tape for the same parameters. The dashed and dotted lines describe the isotherms for T_{grphtn} and T_{dmg} at their respective surfaces. The purple dotted and dashed regions describe the actual range of parameters for spot and scanned LLG respectively. Inset: all four regimes bounded by T_{grphtn} and T_{dmg}.

FIG. 8C depicts a schematic representation of the mechanisms of formation for localized porous graphene (LPG).

FIG. 8D depicts a comparison of representative Raman spectra from (i) HPG, (ii) LPG, (iii) a-C to (iv) ablated PI, normalised to the G peak.

FIG. 8E depicts I_{G}/I_{2D} ratios at 250 kHz within the LLG and high temperature regimes with increasing fluence and no. of pulses.

FIG. 9A depicts Raman spectra of (i) less defective LPG from spot irradiation, (ii) LPG from spot (solid) with equivalent scanning parameters (dashed), and (iii) PI for reference.

FIG. 9B depicts a representative X-ray Photoelectron Spectroscopy (XPS) spectra and deconvoluted peaks of LPG and PI respectively.

FIG. 9C depicts a field emission Scanning Electron Microscope (FESEM) image showing a cross-section view of LPG (written within the LLG regime.) Examples of pores in LPG flakes are marked out in white arrows. The dotted line represents the boundary between unconverted PI and the silicone adhesive. The dash-dot line represents the interface between PI and LPG.

FIG. 9D depicts a FESEM image showing a top view of LPG showing individual flakes and wide, porous structure.

FIG. 9E depicts a FESEM image showing a cross-section view of all layers (i) after LLG including the paper substrate with thermochromic coating. The area marked by the dashed rectangle is shown in FIG. 9C.

FIG. 9F depicts a FESEM image showing a cross-section view of all layers in after writing in the high temperature regime for comparison.

FIGS. 10A and 10B depict cyclic voltammetry (CV) curves of LPG MCs with EMIMBF4 electrolyte at scan rates ranging from 10 mV s⁻¹ to 1000 mV s⁻¹ and from 2 V s⁻¹ to 100 V s⁻¹, respectively.

FIG. 10C depicts an areal capacitance value (C_{A}) calculated from the CV curves as a function of scan rates.

FIGS. 10D and 10E depict galvanostatic charge discharge (GCD) curves of LPG MSCs at various discharging current densities of (i) 0.1-0.5 mA cm⁻² and (ii) 1-10 mA cm⁻² respectively.

FIG. 10F depicts a calculated C_{A} value from the GCD results versus discharge current densities.

FIG. 10G depicts a relative change in resistance versus relative humidity (RH) curve of the LPG humidity sensor.

FIG. 10H depicts a cyclic response of the LPG humidity sensor versus a commercial reference humidity sensor between 4.2% and 76.4% RH.

### DETAILED DESCRIPTION

Where reference is made in any one or more of the accompanying drawings to steps and/or features, which have the same reference numerals, those steps and/or features have for the purposes of this description the same function(s) or operation(s), unless the contrary intention appears.

The following description of the embodiments are further illustrated in the accompanying figures. The following detailed description does not limit the various embodiments. Instead, the scope of invention is defined by the statements attached. In various embodiments below, the term “light stream” may be used interchangeably with the term “beam of light”.

Conductive porous graphene devices created from direct light stream of graphene precursor materials are termed as porous graphene and their integration with a substrate material offers the advantages of high performance offered by the integrated features of this combination.

Moreover, during the laser induced graphene formation, further thermal control can be achieved with ultrashort pulse lasers (τ=picosecond to femtosecond). Deployment of ultrafast laser pulses facilitates vibrational excitation resulting in unique athermal and/or nonlinear interactions with materials and minimal heating; inducing extremely localized physical and chemical changes on the material surface. Hence, this mechanism literally circumvents the need for intermediate states that lead to harmful side effects. Therefore, ultrafast pulse lasers for localised laser induced graphene formation is a promising field for high precision manufacturing of diverse carbon-based electronic applications.

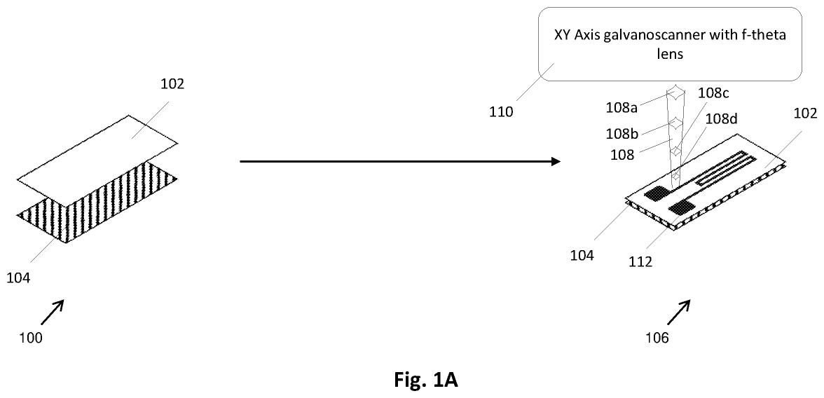

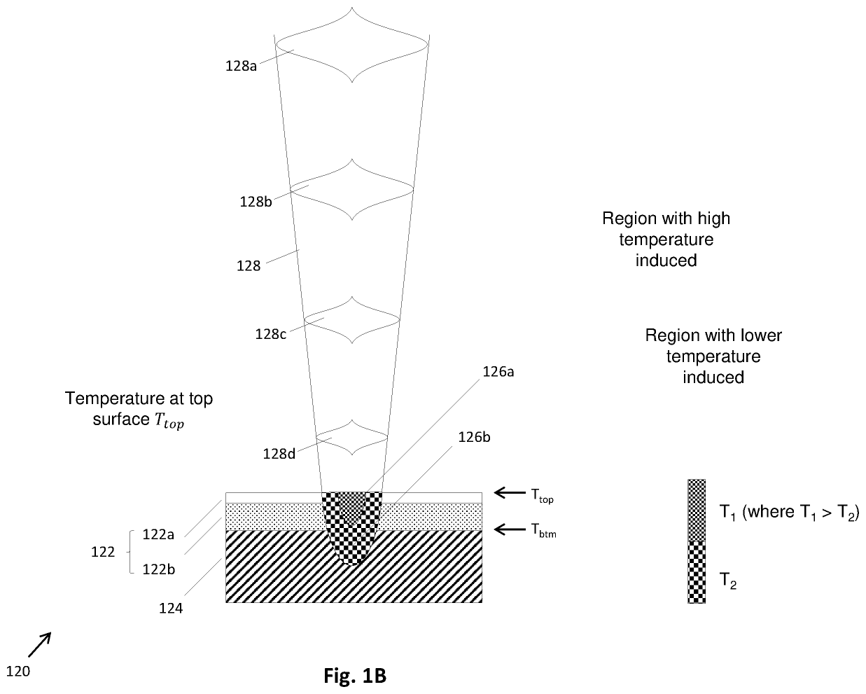

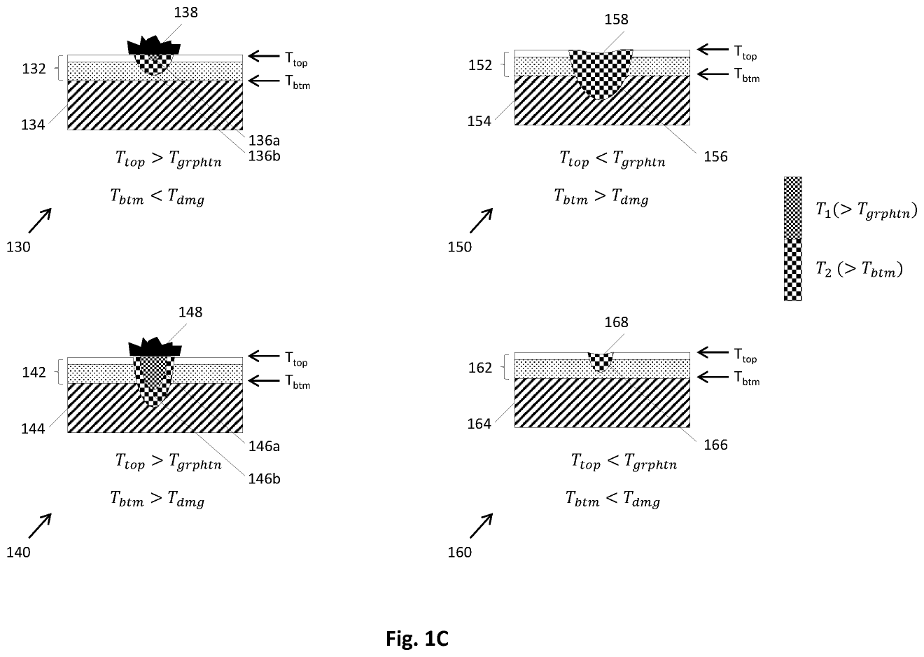

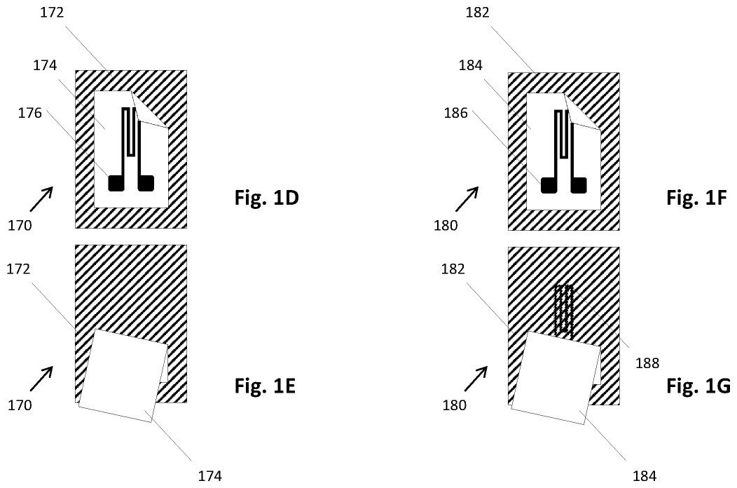

FIG. 1A depicts schematic diagrams for a process for manufacturing a process for manufacturing a porous graphene layer across a precursor material layer 102 on a substrate according to an embodiment of the present disclosure. The process may start at 100 by attaching a precursor material layer 102, such as polymer film like Kapton tape with or without adhesive on a substrate 104. In an embodiment, the substrate is a flexible and/or stretchable substrate (e.g. paper). Subsequently, at 106, a beam of light is generated from a light source (not shown) to a portion of the precursor material layer 102 through a lens 110, e.g. a f-theta lens of a XY-axis galvanoscnaner. In an embodiment, the beam of light 108 is an intermittent light stream where a short light stream pulse is emitted at every time interval (for the sake of simplicity, four light stream pulses such as Gaussian pulses are illustrated in 108a-108d). In another embodiment, the beam of light 108 may be a continuous light stream (not shown).

Where the portion of the precursor material 102 is exposed to the beam of light 108, the temperature of the irradiated portion of the precursor material 102 may rise, and a porous graphene layer 112 is then formed on or above the substrate 104. Advantageously, this offers a direct writing method for manufacturing a conductive porous graphene layer of a desired pattern, for example yielding an electrical circuit design or an electrical current path on the substrate (e.g. as illustrated in 112), by controlling the portion of the precursor material 102 exposed to the beam of light 108. In various embodiments below, such porous graphene manufacturing process using a beam of light is referred to as a light induced graphitisation process.

FIG. 1B depicts a schematic diagram 120 illustrating a process for manufacturing a porous graphene layer across a precursor material layer 122 on a substrate 124 using a beam of light 128 according to an embodiment of the present disclosure. In this embodiment, a precursor material layer 122 comprising a carbon-containing material layer 122a and an adhesive layer 122b is attached on the substrate 124. In various embodiments, the precursor material layer 122 is made of a carbon-containing material such as synthetic or organic polymer. An intermittent light stream 128, i.e. an ultrafast light stream pulse emitted at every short time interval with a repetition rate, is generated to a portion of the precursor material layer 122 (for the sake of simplicity, four Gaussian light stream pulses are illustrated in 180a-180d). The light stream pulse(s) 128a-128d of the light stream 128 is absorbed by the precursor material layer 122, and the absorbed energy of the light stream pulse(s) 128a-128d is then converted into thermal energy immediately after the absorption.

In various embodiments of the present disclosure, the thermal energy generated pursuant to the light absorption may be accumulated locally within the portion of the precursor material layer 122 (hereinafter may be referred to as “localized heating” or “heat generation” or “heat accumulation”) as indicated in a local pulse interaction region 126a. The thermal energy generated due to the light absorption increases the temperature of the portion of the precursor material layer 122 (including near surface portion and bulk portion underneath the surface portion) to a first temperature (T₁) where the beam of light is being directed to.

In this embodiment, the thermal energy generated pursuant to the light absorption may diffuse axially and/or radially, for example away from the local pulse interaction region 126a, in the precursor material 122 and in the substrate 124 forms a diffusion region as indicated in 126b, thus increases the temperature of the diffusion regions 126b to a second temperature (T₂). Generally, the first temperature induced by the localized heating in the local pulse interaction region 126a is greater than the second temperature caused by the heat diffusion in the diffusion region 126b adjacent to it.

According to the present disclosure, an optimal manufacturing regime of a light induced localized graphitisation process describes a regime that allows formation of a porous graphene layer on the top surface of the light irradiated portion of the precursor material layer 122 and prevents thermal damage of the substrate 124 during the process which includes thermal oxidation of the substrate, leads to structural weakening of the substrate and compromises the mechanical stability of the substrate. Hence, it is an object to identify a method for identifying the optimal manufacturing regime of the light induced localized graphitisation process used for manufacturing a porous graphene layer on the precursor material without thermal damage to the substrate.

To identify such optimal manufacturing regime of the light induced localized graphitisation process, two temperature boundaries need to be established, one each for both the top and the bottom surfaces of the precursor material layer 122 respectively. The first boundary for the top surface of the precursor material layer 122 describes a first temperature threshold, for example graphitisation temperature T_{grphtn}, for the precursor material layer 122 to form a porous graphene layer; whereas the second boundary for the bottom surface of the precursor material layer 122 describes a second temperature threshold, for example damage temperature T_{dmg}, above which will likely to cause thermal damage to the substrate 124.

In particular, the temperature of the top surface or local light interaction region 126a near surface of the precursor material layer 122 (Tₜₒₚ or T₁ of FIG. 1B) must reach at least the first (minimum) temperature threshold (T_{grphtn}) in order to form a porous graphene layer; whereas the temperature of the bottom surface of the precursor material layer 122 or diffused through the substrate at regions 126b (T_{btm} or T₂ in FIG. 1B) needs to be kept below the second (maximum) temperature threshold (T_{dmg}) to prevent the substrate from thermally damaged.

FIG. 1C depicts schematic diagrams 130, 140, 150, 160 illustrating formations of a porous graphene layer under four different temperature conditions at the top surface and the bottom surface of the precursor material 132, 142, 152, 162 respectively when exposed to a beam of light according to various embodiments of the present disclosure. In these embodiments, a local light interaction region and a diffusion region are formed at a first temperature T₁ and a second temperature T₂ as a result of localized heating and heat diffusion respectively. The first temperature induced by the localized heating in the local pulse interaction region is greater than the second temperature caused by the heat diffusion in the diffusion region adjacent to it (T₁>T₂).

In the first example, as illustrated in the first schematic diagram 130, a local light interaction region 136a near top surface portion of the precursor material layer 132 is formed at a first temperature higher than the graphitisation temperature (T₁>T_{grphtn}). As the temperature at the top surface of the precursor material 132 is higher than the graphitisation temperature (Tₜₒₚ>T_{grphtn}), a porous graphene layer 138 is formed on the top surface of the precursor material 132. On the opposite side, a diffusion region 136b is formed adjacent to the local light interaction region 136a within the precursor material layer 132 via heat diffusion at a second temperature higher than the damage temperature (T₂>T_{dmg}). The thermal energy does not diffuse away and extend to the bottom surface of the precursor material 132 and the substrate 134. As the temperature at the bottom surface of the precursor material 132 remains lower than the damage temperature (T_{btm}<T_{dmg}), the substrate 134 is not likely to experience thermal damages. Such example describes an optimal porous graphene manufacturing regime.

In the second example, as illustrated in the second schematic diagram 140, a local light interaction region 146a near top surface portion of the precursor material layer 142 is formed at a first temperature higher than the graphitisation temperature (T₁>T_{grphtn}). As the temperature at the top surface of the precursor material 142 is higher than the graphitisation temperature (Tₜₒₚ>T_{grphtn}), a porous graphene layer 148 is formed on the top surface of the precursor material 142. On the opposite side, the thermal energy accumulated and the temperature in the local light interaction region 136a extends to the bottom surface of precursor material layer. Further, a diffusion region 146b is formed adjacent to the local light interaction region 146a and extends to further into the precursor material layer 142 and the substrate 144 via heat diffusion at a second temperature higher than the damage temperature (T₂>T_{dmg}). In this second example, as the temperature at the bottom surface of the precursor material 142 is higher than the damage temperature (T_{btm}>T_{dmg}), the substrate 144 is likely to experience thermal damages.

In the third example, as illustrated in the third schematic diagram 150, the thermal energy generated pursuant to the light absorption is not accumulated locally. Instead, the thermal energy is diffused to the precursor material layer 152 and the substrate 154 and a diffusion region 156 in the precursor material layer 152 and the substrate 154 at a second temperature higher than the damage temperature (T₂>T_{dmg}). As the temperature at the top surface of the precursor material 152 is not higher than the graphitisation temperature (Tₜₒₚ<T_{grphtn}), no porous graphene layer is formed. Instead, a thermal ablation (cutting) and ejection of precursor material is observed and results in an ablation crater 158. In addition, as the temperature at the bottom surface of the precursor material 152 is higher than the damage temperature (T_{btm}>T_{dmg}), the substrate 154 is likely to experience thermal damages.

In the fourth example, as illustrated in the fourth schematic diagram 160, the thermal energy generated pursuant to the light absorption is not accumulated locally. Instead, the thermal energy is diffused to the precursor material layer 162 and a diffusion region 156 in the precursor material layer 162 at a second temperature higher than the damage temperature (T₂>T_{dmg}). As the temperature at the top surface of the precursor material 162 is not higher than the graphitisation temperature (Tₜₒₚ<T_{grphtn}), no porous graphene layer is formed. Instead, athermal ablation (cutting) and ejection of precursor material is observed and results in an ablation crater 166. In addition, the thermal energy does not diffuse away and extend to the bottom surface of the precursor material 162 and the substrate 164. As the temperature at the bottom surface of the precursor material 162 is higher than the damage temperature (T_{btm}<T_{dmg}), the substrate 164 is not likely to experience thermal damages. In an embodiment, an ablation crater is formed as a result of light irradiation and formation of diffusion region 156.

FIGS. 1D and 1E depict a schematic diagram illustrating an electronic sensor 170 comprising a porous graphene layer 176 formed across a portion of a polyimide (PI) film (precursor material layer) 174 on a thermochromic paper (substrate) 172 before and after peeling off the PI film 174 from the substrate 172 respectively according to an embodiment. It is noted that the temperature at which the PI film 174 graphitized is 1775K while the temperature at which the thermochromic paper will experience visible physical change in color is 353K.

In this embodiment, the operation parameters of a light source are determined and controlled such that the temperature at the top surface of the PI film 174 is higher than the 1775K (Tₜₒₚ>T_{grphtn}); whereas the bottom surface of the PI film layer 174 is maintained below 353K (T_{btm}<T_{dmg}). This results in a similar outcome as that in the first example 130 of FIG. 1C. In particular, the porous graphene layer 176 is formed as shown in FIG. 1D. Further, the thermochromic paper 172 does not experience a heating process to a temperature higher than the damage (discoloration) temperature, therefore it does not exhibit any damage or discoloration after the illumination and manufacturing process. This result can be seen in the clean substrate 172 as illustrated in FIG. 1E after peeling off the precursor material from the substrate 172.

On the other hand, FIGS. 1F and 1G depict a schematic diagram illustrating an electronic sensor 170 comprising a porous graphene layer 186 formed across a portion of a polyimide (PI) film (precursor material layer) 184 on a thermochromic paper (substrate) 182 before and after peeling off the PI film 184 from the substrate 182 respectively according to another embodiment. In this embodiment, the operation parameters of a light source may not be determined, controlled and optimized. After exposing the precursor material layer 184 under a beam of light generated from such light source, the temperature at the top surface and the bottom surface of the precursor material layer 184 may above 1775K (Tₜₒₚ>T_{grphtn}) and 353K (T_{btm}>T_{dmg}) respectively. This results in a similar outcome as that in the second example 140 of FIG. 1C. In particular, the porous graphene layer 184 is formed as shown in FIG. 1F. However, due to exposure to heat under a temperature higher than the damage temperature of the thermochromic paper, the thermochromic paper 182 experience damage and discoloration, as illustrated in FIG. 1E after peeling off the precursor material from the substrate 182. Such change in the physical properties of the substrate may affect the mechanical stability and reliability of the electronic sensor 180.

It is noted that heating generation/accumulation and diffusion within a precursor material layer differ based on the material properties of the precursor material layer such as thickness, density (ρ), specific heat capacity (Cₚ), reflectivity (R), absorption coefficient (α), thermal diffusivity (D) and thermal conductivity (κ).

According to the present disclosure, heating generation/acumination and diffusion within a precursor material layer may also differ based on operating parameters of the light source such as repetition rates (f) number of pulses (N), and fluence (F) i.e. energy per area of a single light pulse, pulse width (w), polarization, wavelength (λ), average power, energy intensity and lens orientation.

Hence, by controlling and tuning the operating parameters of the light source generating the beam of light irradiating the precursor material, appropriate temperatures and sizes of the local light interaction region and diffusion region in a precursor material can be realized to achieve the optimal regime for formation of porous graphene layer without thermal damage to the substrate.

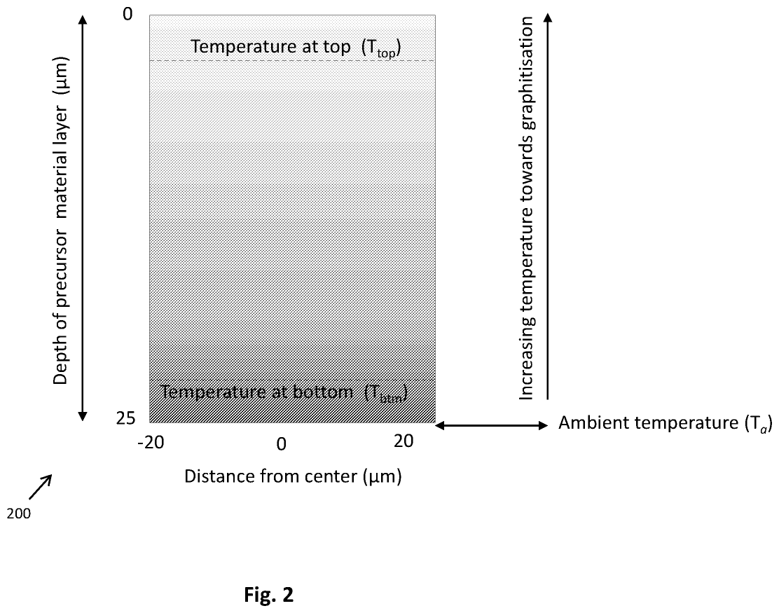

In various embodiments, a temperature profile of a precursor material can be used to predict the formation of porous graphene layer without thermal damage to the substrate with boundary conditions (temperatures) at the top surface and the bottom surface of the precursor material. FIG. 2 illustrates a temperature profile 200 of a precursor material layer (for example the PI film) in a light induced localized graphitisation process according to an embodiment of the present disclosure. The temperature profile shows a temperature distribution across the vertical axis, i.e. the depth (thickness) of the precursor material layer from the top surface, and a temperature distribution across the horizontal axis, i.e. the distance from center of the precursor material, for example a center spot on the precursor material layer exposed to the beam of light or center of the local light interaction region.

In this example, due to heat accumulation and diffusion, the temperature increases from the bottom surface to the top surface. For formation of a porous graphene layer at the top surface, the temperature at the top surface refers to the temperature required for graphitisation. Preferably, the temperature at the bottom surface refers to an ambient temperature to prevent any thermal damage to the substrate underneath or adjoining to the precursor material. However, as it is industrially not practical to use physical thermocouples or other methods to monitor the boundary temperatures for light induced localized graphitisation, there is thus a need for a theoretical model to predict such temperature distribution for identification and tunability of operating parameters of light source.

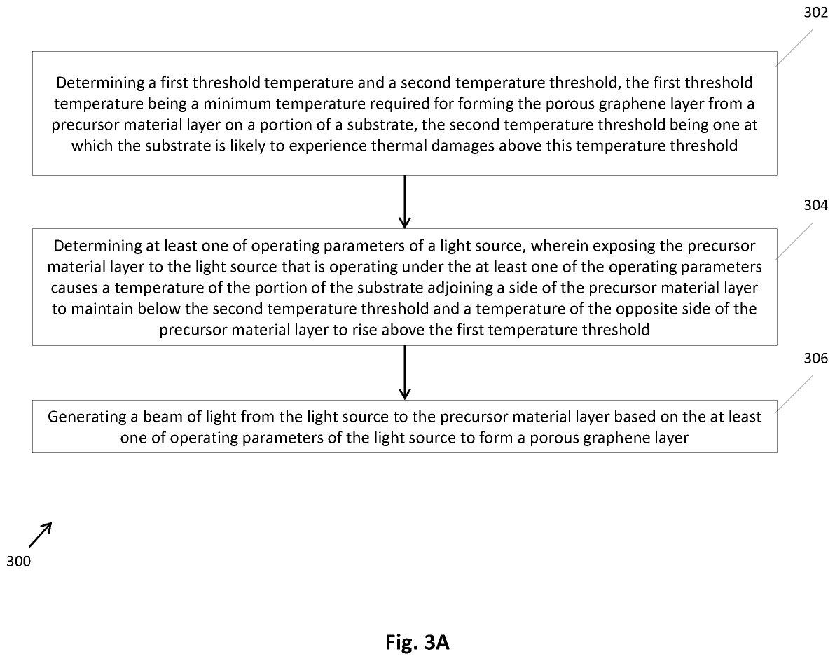

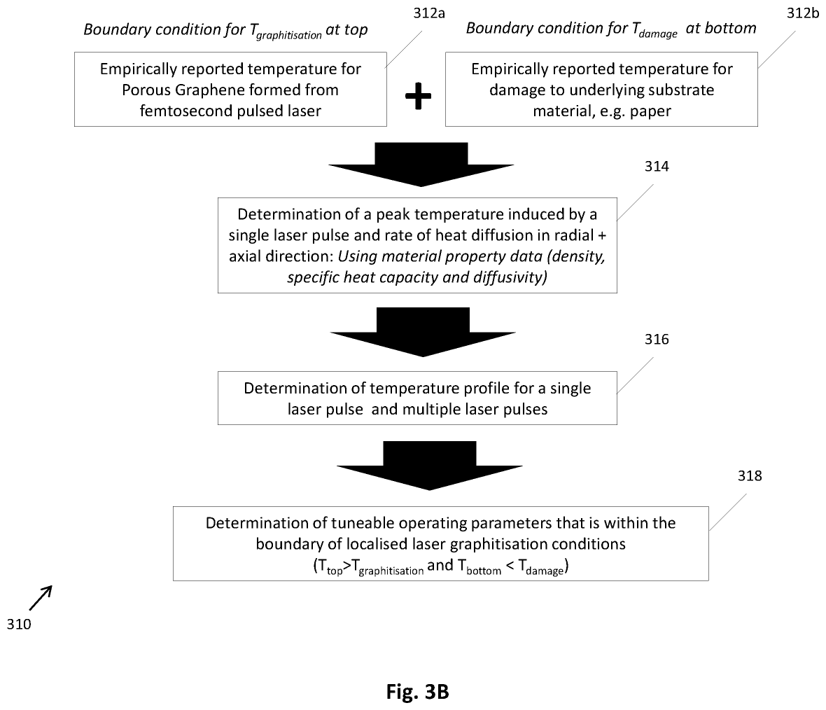

FIG. 3A depicts a flow chart 300 illustrating a method for manufacturing a porous graphene layer across a precursor material layer on a substrate according to various embodiments of the present disclosure. In step 302, a step of determining a first temperature threshold and a second temperature threshold is carried out, where the first temperature threshold is a minimum temperature required for forming the porous graphene layer from a precursor material layer on a portion of a substrate, and the second temperature threshold is one at which the substrate is likely to experience thermal damages above this temperature threshold. In step 304, a step of determining at least one of operating parameters of a light source is carried out, wherein exposing the precursor material layer to the light source that is operating under the at least one of the operating parameters causes a temperature of the portion of the substrate adjoining a side of the precursor material layer to maintain below the second temperature threshold and a temperature of the opposite side of the precursor material layer to rise above the first temperature threshold. Subsequently, in step 306, a beam of light from the light source to the precursor material layer is generated based on the at least one of operating parameters of the light source to form a porous graphene layer.

In various embodiment, prior to step 304, i.e. the determination of the at least one of operating parameters of the light source, the method for manufacturing a porous graphene layer further comprises a step of generating a temperature profile across the precursor material layer based on at least one parameter of the precursor material layer and at least one of operating parameters of the light source. The temperature profile shows a corresponding temperature of each of a plurality of regions (in vertical and horizontal axes) on the precursor material layer including the side (bottom surface) of the precursor material layer and the opposite (top surface) side of the precursor material. Subsequently, step 304 may be carried out based the determined temperature profile.

According to the present disclosure, a theoretical formulation can be developed to determine and optimize operation parameters to alleviate the issue of thermal damage to underlying substrate during localised laser graphitisation process for porous graphene formation. The tuneability of the apparatus or method critically allows for the sequential combination of different thermal and athermal phenomena such as athermal ablation (cutting) and carbonisation/graphitisation (conductive graphene traces) within a single in-situ manufacturing process. The theoretical formulation developed predicts temperature rise through the depth of a material with different laser parameters (time and spatial domain). With this theoretical formulation, optimised operation parameters of the light source can be obtained to induce extremely localised physical and chemical changes to the precursor material layer. The energy could easily remove the material or break and reform bonds in targeted precursor material layer in a single apparatus without thermal damage to any underlying substrate.

According to the present disclosure, when determining the first temperature threshold, i.e. graphitisation temperature of the precursor material, and the second temperature threshold, i.e. damage temperature of the underlying substrate, the determination may be based on empirical data of exposing the precursor material and the substrate respectively to the light source. FIG. 3B depicts a flow chart 320 illustrating a determining at least one of operating parameter a light source of generating a femtosecond pulsed laser (light source) for manufacturing porous graphene layer across a PI film (precursor material layer) attached on a thermochromic paper (substrate) according to an embodiment.

In this embodiment, as illustrated in Step 312a and step 312b of FIG. 3B, the process may start by determining the boundary condition for T_{grphtn} at the top surface and the boundary condition for T_{dmg} at the bottom surface of the PI film. This can be carried out by obtaining data of empirically reported temperature T_{grphtn} for porous graphene formation from its precursor material (i.e. PI) upon ultrashort pulse lasing, where the ultrashort pulse laser consist of femtosecond pulses, as illustrated in step 312a of FIG. 3B; and the corresponding empirical data for minimum temperature threshold for damage T_{dmg} to the underlying substrate (e.g. thermochromic paper) as illustrated in step 312b of FIG. 3B.

For an example, empirical data may suggest as follows: the precursor material is a PI tape, known commercially as Kapton, consisting of a 23 μm thick layer of PI film on a 60 μm thick silicone adhesive layer. The PI tape is directly attached to a thermochromic paper (with a damage temperature threshold of 348K). Femtosecond (fs) pulses at UV wavelength of 343 nm are focused on to the surface of the PI film and the focal position of the x-y plane is computer controlled by a galvanoscanner (Sino-Galvo JD2204 Galvo Scanner) fitted with a f-theta lens (Sino-Galvo f-theta lens) with 160 mm focal length. The laser used is a linearly polarised Ytterbium-fiber femtosecond laser (Amplitude Systemes Satsuma HP) with a 220 fs pulse duration (τp). The direct laser writing process is conducted under ambient environment.

Similarly, in order to establish the temperature at the boundaries of T_{grphtn} and T_{d} as per steps 312a, 312b in FIG. 3B, reference data of empirical values were sourced. As an exemplary reference, temperatures higher than 1775K were found to promote thermal graphitization on femtosecond pulsed polyimide, forming porous graphene, whereas temperatures higher than 348K is an exemplary damage threshold for thermochromic paper.

Subsequently, in step 314, a step of determining a peak temperature induced by one single laser pulse and rate of heat diffusion in radial and axial direction is carried out using material property data such as thickness, absorption coefficient, reflectivity, density and specific heat capacity, thermal conductivity and thermal diffusivity.

For example, the time dependent temperature distribution inside polyimide may be obtained from thermal diffusion equation derived using homogenous boundary condition from Fourier's law of heat conduction and energy conservation as shown in Equation 1. Here T(\vec{r}, t) is the temperature distribution inside the medium (PI film) and f(\vec{r},t) is the rate of heat source inside the medium and D is the thermal diffusivity of the precursor material (PI film).

$${▽}^{2} T ( \vec{r} , t ) - \frac{1}{D} \frac{\partial T ( \vec{r} , t )}{\partial t} = f ( \vec{r} , t ) \qquad ( 1 )$$

It is noted while absorption the femtosecond-pulsed laser light stream by the PI film will increase temperature of the PI film due to heat accumulation and diffusion, some basic rational assumptions are considered for the formulation of femtosecond-pulse induced temperature increment. Among the key assumptions are that photothermal mechanism is the prevailing contributor to material modification. Secondly, multiphoton processes, radiation loss and plasma effect can be neglected. Thirdly, the absorption coefficient (α), reflectivity (R), and density (ρ) of polyimide is assumed to have no strong temperature dependence.

The peak temperature from one single laser pulse is affected by the precursor material properties such as density (ρ), specific heat capacity (Cₚ), reflectivity (R), absorption coefficient (α), as well as the energy per area of a single pulse, fluence (F). In polyimide, individual pulses are assumed to be absorbed in a ‘disk’ width. Polyimide is highly absorptive at 343 nm (UV wavelength), and is governed by the absorption coefficient α, which is especially important in the axial direction.

Further, in step 316, a step of determining a temperature profile for the single laser pulse and multiple laser pulses is carried.

It is noted that the rate of thermal diffusion is expected to occur at differing rates along different directions (radial vs axial) during heating due to absorption of the laser pulse. In polyimide, the temperature profile across polyimide, T₁ (in the axial z and radial r directions) due to one pulse is obtain from peak temperature from one pulse and corresponding rates of thermal diffusion in the axial and radial directions.

Simultaneously, precursor material properties such as specific heat capacity (Cₚ), thermal conductivity (κ), and diffusivity (D=κ/ρCₚ) are affected by the temperature of the material, as described by Equations 2 and 3, using polyimide as the exemplary polymeric precursor material for forming porous graphene:

$${C}_{p} ( T ) = 1000 [ 0.96 + 1.39 ( \frac{T - 300}{400} ) - 0.43 {( \frac{T - 300}{400} )}^{2} ] , \\ 200 K < T < 1500 K \qquad ( 2 )$$

$$κ ( T ) = 100 \times [ ( 1.55 \times {10}^{- 3} ) + ( 6 \times {10}^{- 4} ) ( \frac{T - 300}{400} ) - ( 1.7 \times {10}^{- 4} ) {( \frac{T - 300}{400} )}^{2} ] \qquad ( 3 )$$

By summing up the temperature effect of multiple pulses, N the total temperature profile, T across a time period, t is profiled.

Subsequently, in step 318, a step of determining tuneable operating parameters (e.g. repetition rates (f) number of pulses (N), and fluence (F)) of the light source that is within the temperature boundaries of an optimal localized laser graphitisation condition is carried out. As shown in step 318 of FIG. 3B, based on the temperature profile distribution across the PI film, the localized laser graphitisation conditions can be predicted at varying repetition rates (f) number of pulses (N), and fluence (F) to ensure optimal operation from various operational factor and optimal manufacture regime can be achieved for manufacturing porous graphene layer from the PI film without thermally damaging the thermochromic paper substrate.

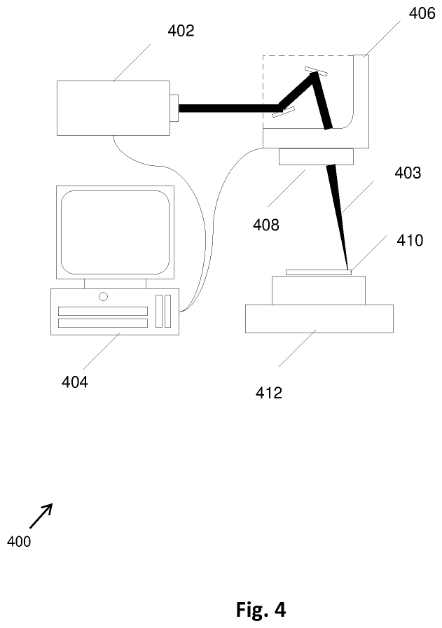

FIG. 4 depicts an apparatus 400 for manufacturing a porous graphene layer across a precursor material layer on a substrate 410 according to various embodiments of the present disclosure. The apparatus 400 may comprises at least one processor and at least one memory including computer program code in a control computer unit 404, the at least one memory and the computer programme code configured to, with at least one processor, cause the apparatus 400 to at least determine a first temperature threshold required for a precursor material layer attached on a portion of the substrate 410 placed on a substrate stage 412 to form the porous graphene layer, and a second temperature threshold being one at which the substrate 410 is likely to experience thermal damages above this temperature threshold.

The apparatus 400 may also be configured to determine at least one of operating parameters of a light source 402, wherein exposing the precursor material layer to the light source 402 that is operating under the at least one of the operating parameters cause a temperature of the portion of the substrate 410 adjoining a (bottom) side of the precursor material layer to maintain below the second temperature threshold and a temperature of the opposite (top, exposed) side of the precursor layer to rise above the first temperature threshold.

After the optimal operating parameter(s) is determined, the apparatus may be configured to generate a beam of light 403 from the light source 402 to the precursor material layer attached on the portion of the substrate 410 based on the at least one of operating parameters of the light source to form the porous graphene layer. In various embodiments, the beam of light 403 may be an ultrafast pulsed laser or a continuous light generated from the light source 402. In an embodiment, the beam of light 403 may be a linearly polarised Ytterbium-fiber femtosecond laser (e.g. generated by Amplitude Systemes Satsuma HP). The beam of light 403 may be directed through a Galvano-Scanner and mirrors (e.g. Sino-Galvo JD2204 Galvo Scanner) 406 and a f-theta lens (e.g. (Sino-Galvo f-theta lens with a 160 mm focal length) 408 before reaching the precursor material and irradiate a spot or portion of the precursor material with the beam of light 403.

In an embodiment, the light source 402 is part of a control system connected to the computer unit 404 and configured to received operation instructions from the computer unit 404 and manipulate the at least one operating parameter(s) of the light source correspondingly. The apparatus 400 may be configured to determine the at least one operating parameters of the control system and/or the light source 402 such as incident fluence, repetition rate, number of pulses, pulse width, polarization, wavelength, average power, energy intensity and lens orientation of the light source, and generate the beam of light 403 based on the operating parameters of the control system and/or the light source 402.

According to the present disclosure, across a depth of a precursor material layer, the two most important regions are the top and the bottom surfaces to determine the critical operation parameters which can form localised laser graphitisation via a light source for porous graphene formation without thermal damage to a substrate underneath.

Hence, operating parameters determination and selection is an important factor for industrial application to achieve an optimal manufacturing scheme for forming a porous graphene layer on a substrate with low likelihood that the substrate experiences thermal damage, as well as high throughput to ensure process efficiency and optimal energy utilization.

In various embodiments, a higher value of incident fluence (F) results in greater energy containment within the pulse, leading to higher temperature induced per light pulse. This is favourable for better graphitisation, however, corresponding increase in energy costs may be one critical factor for consideration. Secondly, in case the beam of light is an intermittent light stream emitting a light pulse every time interval, effect of a higher repetition rate (f) of the light pulses results in a shorter time period between pulses (τ_{L}), leading to less heat diffusion away from the area per pulse. Therefore, with increasing f, more heat can be accumulated within the precursor material. Moreover, due to the greater propensity of heat accumulation at higher repetition rate, the underlying material attached to the bottom of the precursor substrate may be more susceptible towards thermal damage.

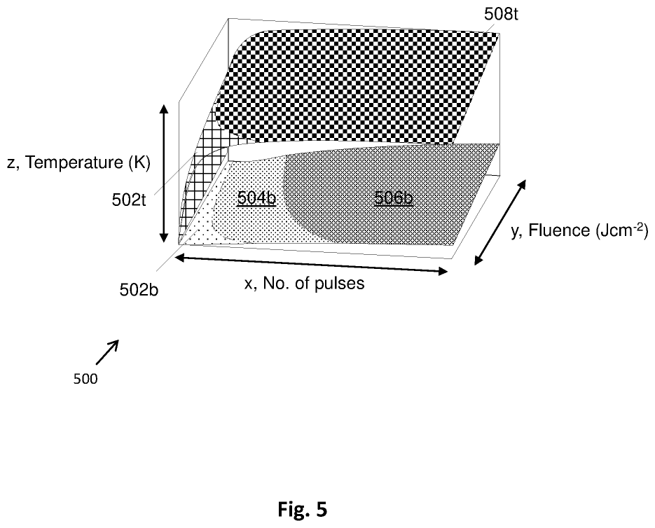

FIG. 5 depicts a temperature 3D graph 500 illustrating predicted temperatures at the top and the bottom surfaces of a precursor material upon exposing to a light source generating an intermittent light stream operated under various fluences and number of pulses at a light pulse repetition rate of 250 kHz and according to an embodiment. In particular, the temperature graphs 502b, 502t show predicted temperatures at the top and the bottom surface of the precursor material respectively when the light source is operated under low fluence and low number of pulses. The temperature graph 502t reflects a temperature lower than the graphitisation temperature (e.g. 1775K for PI film) of the precursor material at the top surface (Tₜₒₚ<T_{grphtn}), and the temperature graph 802b reflects a temperature lower than the damage temperature of the substrate (e.g. 348K for thermochromic paper) at the bottom surface (T_{btm}<T_{dmg}). Hence, based on the prediction of the theoretical formulation of the present disclosure, when the fluences and the number of pulses of the light source are operated under the ranges corresponding to the temperature graph 502b/502t, no porous graphene layer will form on or above the substrate and the substrate is not likely to experience thermal damage.

The temperature graph 504b shows predicted temperatures at the bottom surface of the precursor material when the light source is operated under moderate fluence and moderate number of pulses; whereas the temperature graph 506b shows the same when the light source is operated under high fluence and high number of pulses. The temperature graph 504b reflects a temperature lower than the damage temperature of the substrate at the bottom surface (T_{btm}<T_{dmg}); whereas the temperature graph 506b reflects a temperature higher than the damage temperature of the substrate (T_{btm}>T_{dmg}). Hence, based on the prediction of the theoretical formulation of the present disclosure, the fluences and the number of pulses of the light source are operated under the ranges corresponding to the temperature graph 504b, it can be predicted that the substrate is not likely to experience thermal damage, but the opposite will likely to occur when the fluences and the number of pulses of the light source are operated under the ranges corresponding to the temperature graph 506b.

The temperature graph 508t shows predicted temperatures at the top surface of the precursor material when the light source is operated under moderate fluences and number of pulses (corresponding to that in temperature graph 504b) to high fluences and number of pulses (corresponding to that in temperature graph 506b). The temperature graph 508t reflects a temperature higher than the graphitisation temperature (Tₜₒₚ>T_{grphtn}). Hence, based on the prediction of the theoretical formulation of the present disclosure, the fluences and the number of pulses of the light source are operated under the ranges corresponding to the temperature graph 504b and 506b, it can be predicted that a porous graphene layer will form on and above the substrate.

Collectively, it can be predicted that the optimal range of operating parameters for fluences and number of pulses under a repetition rate of 250 kHz falls in the range corresponding to the temperature graph 504b, where the temperature at the top surface is always in a range higher than the graphitisation temperature (Tₜₒₚ>T_{grphtn}), and the temperature at the bottom surface is always in a range lower than the damage temperature (T_{btm}<T_{dmg}).

As such, the boundary for the required number of pulses and corresponding fluence can be defined as shown in FIG. 5 to ensure optimal operation from various operational factors and optimal manufacture regime can be achieved for manufacturing porous graphene layer, for example in this case, from the PI film without thermally damaging the thermochromic paper substrate.

According to the present disclosure, the porous graphene layer is manufactured and applied in carbon-based electronic devices; however, a skilled person would appreciate that such porous graphene layer can also be manufactured on a film or a non-electronic substrate, and has functional applications in non-electronic devices such as air filters, composite materials and anti-fouling films in bioseparation technology. In various embodiments, the operating parameters will be determined and selected in consideration of the different functions and applications of the porous graphene layer (such as heat sensing, pressure sensing, supercapacitor, strain sensing, power sources, heating elements, integrated circuits, actuator, energy source (capacitors/battery), light source, air filter, composite materials, anti-fouling film for bioseparation, etc.).

FIG. 6 depicts schematic diagrams illustrating a top view 600 and a cross-section view 602 of two porous graphene layers 606, 608 formed above a flexible substrate 604 for respective applications of a humidity sensor 610 and a microsupercapacitor 612 according to an embodiment. In this embodiment, respective operating parameters of the light source may be determined and selected such that different light streams are generated to the precursor material layers 610, 612 to manufacture the designated porous graphene layers 608, 608 useful and optimized for the function and application as humidity sensor and microsupercapacitor. The humidity sensor 610 and the microsupercapactor is connected through conductive silver ink on the flexible substrate 604. The operating parameter of the light source may be optimized based on operational efficiency (energy, processing time, cost factors) and other factors which may not be stated herein, with the main objective of improving and optimizing the industrial processing method.

Additionally or alternatively, in various embodiments, new material properties, not limited to absorption coefficient, reflectivity, density, specific heat capacity, diffusivity and thermal conductivity of the precursor material layer, may be factored in the equations for determining variety of light source operating parameters such as incident fluence, repetition rate and number of pulses.

On the other hand, regarding the number of pulses N, with increase in number of pulses, the total temperature induced in the material increase; leading to increase in processing time. An increase in processing time may result in incur of higher costs for the operations, depending on other factors such as energy consumption. Another variable parameter would be the beam width w of the laser, which directly affects fluence, since with increase in beam width, the area increases, hence energy per unit area, i.e. fluence decreases. The factors mentioned herein, are among the important industrial processing considerations and may include other factors and operating parameters such as polarization, wavelength, average power, energy intensity and lens orientation which are not described in the present disclosure.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

### Materials and Methods

### Preparation of Materials

Polyimide (PI) tape (3M Electrical Tape Series 92) consisting of a 23 μm thick layer of PI film on a 60 μm thick silicone adhesive layer (measured directly using micrometers) is used as the precursor and substrate for femtosecond porous graphene (LPG) formation. The PI tape is directly attached on a sheet of thermochromic (generic brand, ink reacts at approximately 348K) paper, which is then affixed on a rigid glass slide 1 mm thick. Before writing, the surface of the PI film is cleaned with ethanol to remove organic contaminants. After writing, the PI tape is gently removed from the surface of the thermochromic paper to analyse any discolouration of the thermochromic paper from heating.

### Parametric Control of Femtosecond Pulses

Writing on the PI film/thermochromic paper samples is done by means of focusing femtosecond (fs) pulses on to the surface of the PI tape (adjustable via a manual x-y-z-stage). Control of the focal position in the x-y plane is achieved through a computer-controlled galvano-scanner (Sino-Galvo JD2204 Galvo Scanner) fitted with a f-theta lens (Sino-Galvo f-theta lens) with 160 mm focal length. The beam waist ωₜₕₑₒ. wₜₕₑₒ (47 μm) is measured directly using the knife-edge method.

The laser used is a linearly polarised Yb-fiber femtosecond laser (Amplitude Systemes Satsuma HP) with a 220 fs pulse duration (τₚ) and adjustable f from single shot to 2 MHz. The third harmonic (THG) wavelength (343 nm) is used for fsDLW, to maximise single photon absorption for PI, which is highly absorbing in the UV spectrum. All writing is done under ambient conditions.

Optical components are installed along the beam path to control the laser parameters under investigation. Coarse control over F is achieved using a half-wave plate, polarizing beam splitter and beam dump, while a second half-wave plate is used to control the polarization of the beam. Past the second half-wave plate, pulses are directed into the galvano-scanner, where they are focused onto an adjustable x-y-z sample stage. Finer control over F and other parameters such as f and N is achieved through the installed laser control software (Eastern Logic MarkingMate). A photodiode (Thorlabs PDA36A Si switchable gain detector) is placed near the beam dump to collect scattered pulses and is connected to an oscilloscope (Rigol MSO1104Z Oscilloscope) for verification of f and N independent of the software.

### Device Fabrication

Simply demonstrating that LPG can be formed without base substrate damage is insufficient. To showcase the usefulness of LLG for robust paper electronics, actual devices will need to be fabricated. The main challenge for fabricating devices with LLG would be to translate results from irradiation at a single spot to scanning or writing across an area. A simple scanning strategy is used, where the number of pulses incident on single spot N is treated as equivalent to N pulses across the theoretical beam diameter (wₜₕₑₒ=46 μm). In this manner, N can be translated to N per mm, which is further translated to an equivalent scan speed based on f. F and f are taken to be the same. Single lines are written by the galvanoscanner in this manner. Fabricating arbitrarily shaped devices is then a matter of writing multiple lines that overlap perpendicular to the writing direction. An overlap of 50% is chosen to minimise overwriting, which would cause results to deviate from what was previously established, while still ensuring electrical contact across the written area and ensuring that all areas are exposed to an equal amount of fluence. Lines are written in a single direction to minimise heat build-up at corners. Furthermore, the scan speed is kept constant across the written area by ensuring that the mirrors have additional time to fully accelerate or decelerate before writing begins. This correction removes any differences that may result from drawing shorter lines versus longer lines in designs with uneven geometries. In this manner, parameters for LLG can be effectively translated to those suitable for fabricating actual devices.

### Material Characterisation

Raman spectroscopy is used to identify the characteristics of the LPG and other carbonaceous materials formed both from single spots and the larger devices formed. Raman spectra (Renishaw InVia Raman microscope) are obtained by exciting the written carbon materials using a 633 nm laser at 100× magnification (unless otherwise stated), and peak positions and widths are obtained from peak fitting with OriginLabs software.

Optical characterisation of the thermochromic paper after writing is conducted with a Keyence VK-250 Confocal Microscope with a 50× objective.

Nanoscale structural characterisation of the surface and cross-sections of the LPG and PG samples are done using a Field Emission Scanning Electron Microscope (FESEM) (JEOL JSM-7600F).

The chemical composition and structure of LPG and PI is investigated through x-ray photoelectron microscopy. XPS spectra are obtained from scanned 10×10 mm LPG samples using a PHI 5400 spectrometer with a 250 W Al Kα source under vacuum.

The reflectivity of the PI film used (at 343 nm) is obtained by illuminating a piece of PI film with adhesive removed mounted in an integrating sphere (Labsphere integrating sphere), using the same THG (343 nm) beam. The incident beam is first split into two by a plate beam splitter into a reference arm and a measurement arm. To reduce the fluence incident on the PI film such that carbonisation or ablation does not occur, the THG beam on the measurement arm is first defocused via a convex lens before entering the integrating sphere. A power meter, placed at one of the openings orthogonal to the PI film collects the scattered pulses diffusely reflected off the PI film, while another power meter at the reference arm provides a reference measurement to account for any fluctuations in beam fluence during measurement. Before measuring reflectivity, calibration of the integrating sphere and the power meter is first done by replacing the PI film with a diffuse reflectance standard (Labsphere Spectralon 99% diffuse reflectance standard) and measuring the average power at various fluences. These average power values are then used to normalise the measured power values at the same fluences reflected from the PI film.

The percentage transmission of PI (at 343 nm) is obtained by measuring the power of the same THG (343 nm) beam transmitted through a sample of PI film with adhesive removed. Similar to the reflectivity measurement, the incident is first split into a measurement and reference arm by a plate beam splitter, where the reference arm provides a reference power measurement. Similarly, the THG beam on the measuring arm is first defocused by a convex lens to reduce potential damage before falling on the surface of the PI film. A power meter is placed directly behind the PI film to capture all of the light that might be diffusely scattered while being transmitted through the film. Calibration of the set-up is done by measuring the average power incident on the power meter without the PI film at various fluences. As before, these average power values are then used to normalise the measured power values at the same fluences transmitted through the PI film.

### Determination of Thermal Damage at Bottom Surface of PI Tape

To simplify the determination of thermal damage at the bottom surface of PI, thermochromic paper, which changes colour upon heating at a similar temperature (348 K) can be used. While the specific formulation of thermochromic paper used would be a trade secret, thermochromic paper generally consist of two distinct parts, a base made of conventional paper, and a thermochromic coating that reacts upon heating to form coloured regions. The thermally sensitive coating is a three-part mixture of chiefly a colour developer, colour-changing leuco dye, and a solid-phase solvent with a melting point at the temperature where colour change is required. In this particular case, the required temperature is 343K. When heated above its melting point, the solvent melts and the developer and leuco dye are able to react, forming a coloured compound which is preserved as the solvent resolidifies. Without sufficient heating, the leuco dye cannot undergo a chemical reaction to its coloured form, and the coating remains uncoloured. Therefore, by attaching the PI film directly to the thermochromic coating and then subjecting the PI film to laser irradiation, whether T_{btm}>T_{dmg} (second condition for LLG) can be determined by observing the presence of any colour changes to the thermochromic paper below.

To rule out the effect of photochemically-induced coloration, a separate set of experiments were conducted with a thin glass slip between the PI and thermochromic paper, acting as a thermal barrier. Throughout the set of parameters no coloration was observed, therefore colouration of the thermochromic layer can be fully attributed to heating.

### Device Characterisation

A layer of PI is first adhered onto the paper substrate before subsequent writing via LLG to form an interdigitated in-plane LPG MSC. To reduce the resistance of current collectors, a combination of conductive silver epoxy and conductive silver ink is used to form conductive traces between the active area of the MSC and the rest of the device. The conductive silver ink and epoxy is simultaneously sintered alongside the graphitisation to form a good and secure electrical connection between the interdigitated pattern and current collector. An additional layer of PI is used to secure the joints as well as provide a ‘well’ to contain the electrolyte.

The LPG MSCs are assembled in an argon-filled glovebox and connected to a potentiostat (VMP3, Bio-Logic Inc.) to investigate electrochemical properties. A few droplets of 1-ethyl-3-methylimidazolium tetrafluoroborate rare applied on the LPG electrodes as an electrolyte and a rest time of six hours is applied to soak the electrolyte. Cyclic voltammetry (CV) and Galvano charge discharge (GCD) tests are conducted and areal capacitances (C_{A}) were calculated from the CC and GCD results. The equation for the calculations are as below.

C_{A} is calculated from the CV curves using through Equation (4):

$${C}_{A} = \frac{1}{2 \times S \times v \times ( {V}_{2} - {V}_{1} )} {\int }_{{V}_{1}}^{{V}_{2}} I ( V ) d V \qquad ( 4 )$$

where S is the LPG surface area and v is the scan rate. V₁ and V₂ are the potential window during the CV measurement, where ∫_{V}_{₁}^{V}^{₂}I(V)dV is the integrated area of CV curve. C_{A} is calculated by the GCD curves as well through Equation (5);

$${C}_{A} = \frac{I}{S \times ( d V / dt )} \qquad ( 5 )$$

where I is the discharge current, S is the LPG surface area, and dV/dt is the slope of the galvanostatic discharge curve.

A simple serpentine structure is chosen for the humidity sensor and is fabricated in a manner similar to the MSC, with current collectors written in place before subsequent sintering/LLG. A second layer of PI is added above to secure and mask the connections such that only the LPG area is exposed to humidity.

RH sensing is achieved by applying a voltage (1 V) across the sensing area and measuring the changes in the electrical properties via a source-measure unit (SMU) (Keysight B2900A Source Measure Unit). The LPG sensor and a commercial reference temperature and humidity sensor (Sensiron SDC30) are then both placed in a lab-built environment chamber, and humidity levels are varied to investigate the response of the LPG humidity sensor relative to the reference sensor (more details included in the Methodology section). Humidity levels are reduced by means of purging water vapour using argon gas or increased by bubbling argon through water and channelling water vapour into the chamber. Humidity measurements are taken along with temperature, and temperature measurements are found to only vary within 1K. The effect of temperature on LPG is therefore regarded as negligible.

### Results

### Example 1

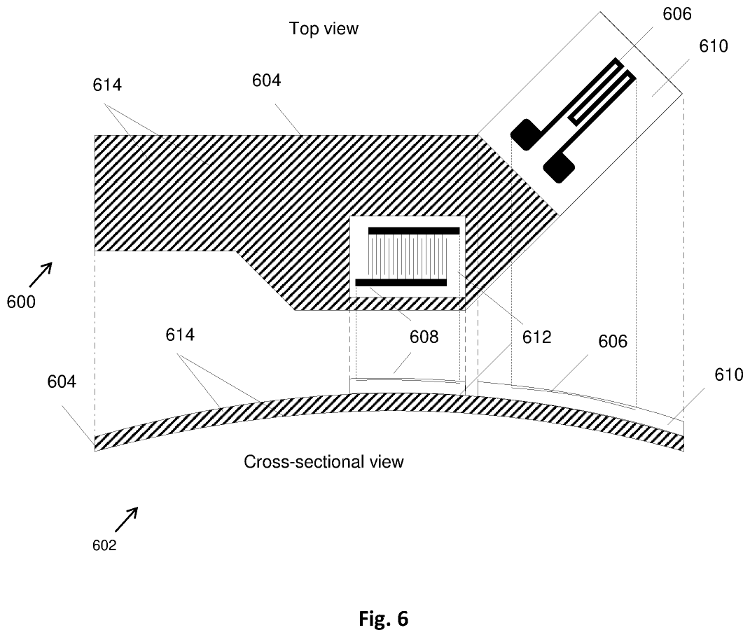

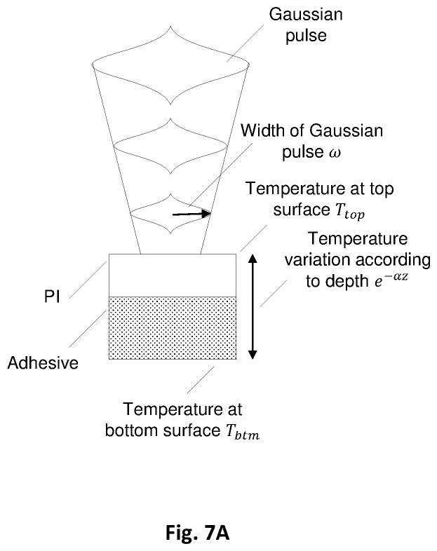

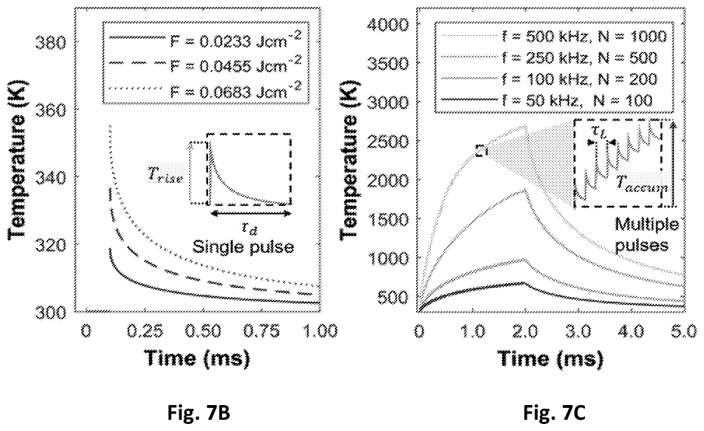

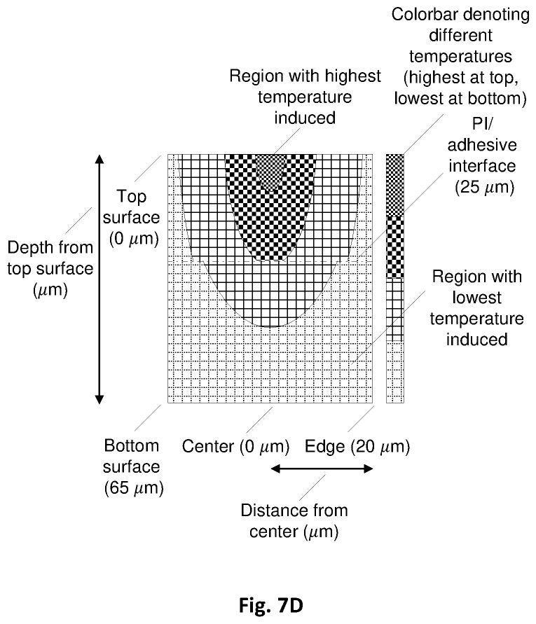

Developing an analytical model requires a clear picture of the arrangement of materials in the region of interest. The region of interest as shown in FIG. 7A can be regarded as a two-layer tape system with a 25 μm PI layer followed by a 40 μm of silicone adhesive (compressed from 70 μm through adhesion) to make up a total of 65 μm adhered onto paper. These values are approximations, as the thickness varies across the surface and are obtained from FESEM cross-section measurements. The time and space dependent temperature distribution T(\vec{r}, t) inside both PI and the adhesive layer can be obtained from thermal diffusion equation given by Equation (6).

$${▽}^{2} T ( \vec{r} , t ) - \frac{1}{D} \frac{\partial T ( \vec{r} , t )}{\partial t} = f ( \vec{r} , t ) \qquad ( 6 )$$

Here f(\vec{r}, t) is the rate of heat source inside the medium defined (Equation (7)) as the time derivative of generated heat density (Qₗₐₛₑᵣ(\vec{r}, t)). Femtosecond pulses arriving on the surface of PI first rapidly excite electrons within the duration of the pulse, before energy from these excited electrons are transferred to the lattice over a far longer timescale. For PI, the rate of conversion of electronic to heat (vibrational) energy occurs roughly at 30-40 μs, while the time taken for the generated heat to diffuse away one absorption length (1/α) of PI (D≈10-7 m2 s⁻¹) is calculated (diffusion length=\sqrt{4Dt}) to be 50 μs. Therefore, it takes a significantly longer (6 orders of magnitude) amount of time for the heat to diffuse away than for heat to be generated. Consequently, generation of heat via the transfer of energy from excited electrons to the lattice results in swift heating upwards of 1014 K s⁻¹. The time dependency of the source term f(\vec{r}, t) can thus be described by a fs-pulse having Dirac delta time function, δ(t). By considering the Gaussian transverse spatial distribution and using the Beer-Lambert law, the source term can be written as follows:

$$f ( \vec{r} , t ) = - \frac{1}{ρ {C}_{p} D} [ \frac{\partial {Q}_{laser} ( \vec{r} , t )}{\partial t} ] = - \frac{1}{ρ {C}_{p} D} [ α ( 1 - R ) {Fe}^{- α z} {e}^{- ( \frac{2 {r}^{2}}{{ω}^{2}} )} δ ( t ) ] \qquad 7$$

Here r is the radial distance from the centre of the focal spot and ω is the focal spot radius that follows the Gaussian beam propagation (Equation (8)).

$$ω = {ω}_{0} {\{ 1 + {[ \frac{λ z}{π {ω}_{0}^{2}} ]}^{2} \}}^{1 / 2} \qquad ( 8 )$$

The pre-exponential term in Equation (7) contains information of the material properties of both materials, such as density (ρ), specific heat capacity (Cₚ), reflectivity (R), absorption coefficient (α) and thermal diffusivity (D). The temperature raised due to a single fs pulse is obtained by solving the heat equation (Equation (6)) with the source term given in Equation (12). The solution at the surface (z=0) can be obtained using Green's function method with initial conditions T(\vec{r}, 0)=300 K.

$${T}_{1} ( r , z , t ) = \frac{{T}_{peak}}{2 \sqrt{π} ( 1 + τ )} exp [ - \frac{2 {r}^{2}}{{w}^{2} ( 1 + τ )} ] {T}_{z} ( z , t ) \qquad ( 9 )$$

Here, Tₚₑₐₖ=(α(1−R)F)/(ρCₚ) is the pre-exponential term from Equation (7) and describes the instantaneous peak temperature raised due to the fs pulses. After the heat is generated, the term τ=4Dt/w² in the denominator determines the rate of heat diffusion along radial and axial directions. As discussed previously, energy absorption and thermal diffusion processes can be treated as separate events in the femtosecond pulse regime, as the laser pulse duration is very short compared to the electron-lattice coupling time. The absorbed energy is then assumed to be converted into thermal energy describable by Boltzmann statistics immediately after absorption. In this regime, the longitudinal (z) distribution of temperature along the depth (z) of the sample can be prescribed by exponential decay function e^{-αz}, where α is the linear absorption coefficient of the material under consideration (FIG. 7A). Considering this initial exponential decaying function, the longitudinal part of temperature distribution after inclusion of thermal diffusion in PI can be written as:

$${T}_{z} ( z , t ) = exp ( {α}^{2} Dt ) [ {e}^{- α z} erfc ( {α ( Dt )}^{1 / 2} - \frac{z}{2 {( Dt )}^{1 / 2}} ) + \qquad ( 10 )$$

$${e}^{α z} erfc ( {α ( Dt )}^{1 / 2} + \frac{z}{2 {( Dt )}^{1 / 2}} ) ]$$

Heat generation and diffusion within the PI and adhesive layers differ based on the material properties of both materials accordingly. Therefore, the combination of heat generation and diffusion in the two-layered medium results in the overall temperature distribution T(\vec{r}, t) for a single pulse. During the formulation of fs-pulse induced temperature increment in PI and the silicone adhesive, several assumptions have been taken into consideration. First, the bond dissociation energies for ground electronic states in polyimide can be estimated to range from 5 eV to greater than 8 eV. Thus, the major contribution in the material modification is by the photothermal mechanism, although photochemical process cannot be ruled out completely. Secondly, multiphoton processes were ignored, since the excited states are expected to last of the order of tens of picoseconds for PI. Third, during the laser irradiation, any radiation loss and plasma effect have been neglected. Fourth, PI is assumed to transition through an intermediate amorphous carbon (a-C) stage during transformation into PG/LPG. Fifth, the absorption coefficient (α), reflectivity (R) and density (ρ) of PI is assumed to have no strong temperature dependence, and are similar to that of subsequently formed a-C and LPG. Sixth, the optical properties of the silicone adhesive layer between PI and the paper substrate are not considered in the thermal model. Lastly, thermal accumulation modelling was assumed to be performed on a heated, but non-ablated PI surface for simplicity.

The reflectivity (R) and absorption coefficient (α) of the PI film at 343 nm was measured using an integrating sphere and found to be 0.082 and 2.1246×105 m−1 respectively. The density of the PI film was taken to be 1.42×103 kgm−3. The only temperature dependent parameter considered in the modelling is the thermal diffusivity (D) which depends on thermal conductivity (K) and specific heat capacity (Cₚ) through the relation, D=κ/(ρCₚ). The temperature dependency of Cₚ and κ is taken stepwise to account for material changes from PI to LPG occurred due to heat accumulation. Between 300 K-858 K, Cₚ(T) and κ(T) is adopted from the reported empirical expression, beyond which carbonisation is reported to begin. Beyond 858 K, complete formation of a-C and subsequently graphene is assumed, and Cₚ(T) is taken to be constant, as both a-C and graphene Cₚ share similar Cₚ values at 858 K. Following similar reasoning, κ(T) is taken to be constant for 858 K<T<1775 K. At and above 1775 K, PI is assumed to be fully converted to LPG, and K is taken to be 0.7 Wm−1K−1 based on reported values for similar PG. These conditions are summarised as follows:

$${C}_{p} ( T ) = \{ \begin{matrix}\begin{matrix}1000 [ 0.96 + 1.39 ( \frac{T - 300}{400} ) - \\ 0.43 {( \frac{T - 300}{400} )}^{2} ]\end{matrix} & if 300 K \leq T < 858 K \\ {C}_{p} ( T ) & if T \leq 858 K\end{matrix} \qquad ( 11 )$$

$$κ ( T ) = \{ \begin{matrix}\begin{matrix}100 \times [ ( 1.55 \times {10}^{- 3} ) + \\ ( 6 \times {10}^{- 4} ) ( \frac{T - 300}{400} ) - ( 1.7 \times \end{matrix} & if 300 K \leq T < 858 K \\ κ ( T ) & if 858 K \leq T < 1775 K \\ 0.7 & if T \leq 1775 K\end{matrix} \qquad ( 12 )$$

For simplicity, no temperature dependent material properties are considered for the silicone adhesive, and the thermal conductivity of the silicone adhesive is taken to be similar to PI without heating. By considering the material properties of PI, the temperature-rise and subsequent temperature distribution due to a single pulse can then be determined for different fluences, as described in FIG. 7B. When considering a train of femtosecond pulses with a repetition rate (f), heat is generated at time intervals of t_{L}=1/f. The temperature profile is modified each time a new laser heating pulse arrives, by an instantaneous temperature rise (T₁). Thus, the temperature rise due to N number of pulses can be written by a summation of temperatures by each individual pulse (n) that depends on the repetition rate 1/t_{L} as follows.

$$T = {T}_{a} + {\sum }_{n = 0}^{N - 1} [ {T}_{1} ( t - n {t}_{L} ) H ( t - n {t}_{L} ) ] \qquad ( 13 )$$

Here, Tₐ=300 K, the ambient temperature and H(t−nt_{L}) is the Heaviside function which ensures that the pulses that have not reached the surface at the time of consideration (t) has no effect on the thermal accumulation. During thermal accumulation, the temperature effect from previous pulse has been considered through temperature dependency of Cₚ and K using Equations (11) and (12). The final temperature T is taken at the point of maximum heating from the last pulse. Temperature accumulation due to multiple pulses can then be predicted at varying repetition rates f, number of pulses N and fluence F, as shown in FIG. 7C. From Equation (8), it follows that a larger N will need a smaller F to reach the same temperature and vice versa.

Across the depth of the two-layer PI/adhesive system, the two most important surfaces to consider are the top and bottom surfaces of the two-layer system to determine the parameters for forming LPG. Considering the temperature induced radially (x, y direction) and axially (z direction) for a single set of parameters (f, F and N), the temperature distribution in three dimensions can be modelled, from the top surface (z=0 μm) of the PI to the bottom surface of the silicone adhesive (z=65 μm), with the PI/adhesive interface at 25 μm as shown in FIG. 7D. From this temperature distribution, the top (Tₜₒₚ) and bottom (T_{bottom}) surface temperatures across a wide range of parameters can therefore be modelled.

To identify the optimal LLG regime, two temperature boundaries need to be established, one each for both the top and bottom surfaces. The first boundary for the top surface of the PI describes the minimum temperature threshold for the formation of LPG. It has been reported that, for conventional isothermal heating of Kapton films, degradation occurs upon heating above approximately 850K in ambient conditions to form a-C with a low to minimal degree of graphitisation. Temperatures higher than 1775K are required to promote thermal graphitization, leading to the formation of LPG. Effectively, temperature can be taken as a proxy to predict the formation of LPG. Therefore, a surface temperature (Tₜₒₚ) of 1775K can be taken as a useful lower temperature threshold (T_{graphitisation}) to determine the formation of LPG.

On the opposite (bottom) surface, the temperature diffused through the PI and adhesive layer needs to be kept below a damage threshold temperature for the base paper substrate. Paper has an autoignition temperature of 491K to 519K, but damage owing to cellulose oxidation (yellowing) can begin at far lower temperatures, starting from 353K. This cellulose damage leads to structural weakening of paper, compromising the mechanical stability of the substrate. The maximum temperature induced by the formation of LPG devices therefore must be below 353K. To visualise thermal damage during experimental validation resulting from temperatures at and above 353K, thermochromic paper, which changes colour upon heating at a similar temperature (348K) is attached to the base of the PI film. When heating is induced by femtosecond pulses, thermal diffusion through the PI film would heat the bottom surface of the PI, causing colour changes on the thermochromic paper above a threshold of 348K. Since colour changes due to heating in thermochromic paper are generally accurate to within 5K, thermochromic paper can be used to visualise thermal damage to paper above 353K. Therefore, 348K is an adequate temperature boundary for damage (T_{dmg}) at the bottom surface of the PI (T_{btm}).

When combined with the developed temperature model, these two temperature boundaries (1775K at the top surface and 348K at the bottom surface) can then be used to determine an optimal regime for LLG by defining two boundary isotherms on a plot of temperature against laser parameters. An example of the optimal LLG regime bounded between T_{graphitisation} and T_{dmg} are visually depicted in FIG. 5 for 250 kHz.

### Example 2

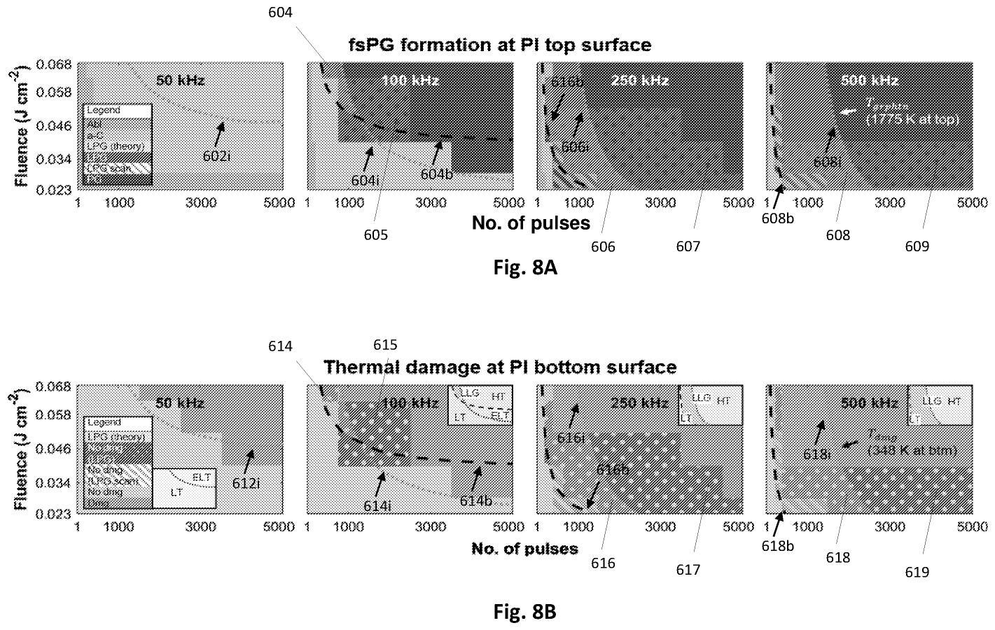

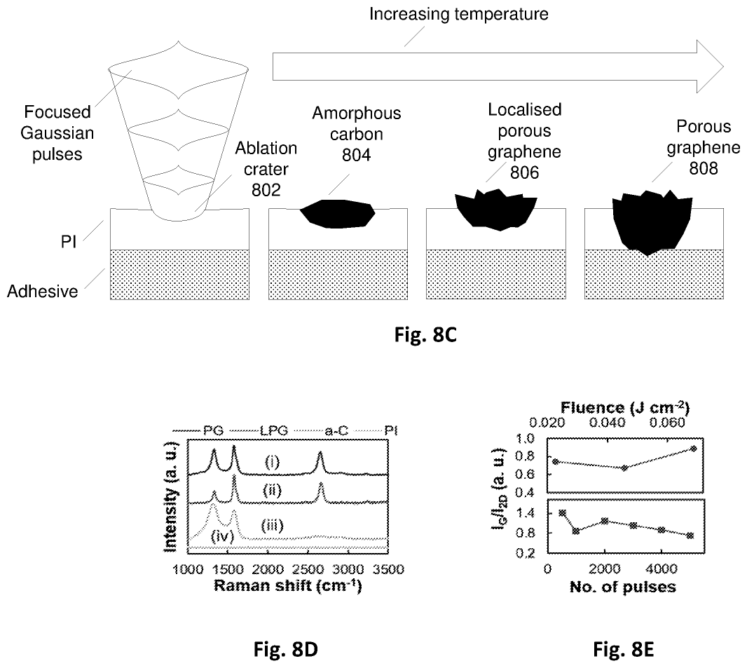

Experimental validation reveals that the LLG regime predicted by the temperature model is relatively accurate across the different repetition rates. even though it underpredicts LPG formation at lower F and higher N for 100, 250 and 500 kHz (T_{btm} higher than expected). As predicted, no LPG formation is observed at 50 kHz at all, while LPG formation is observed at 100 kHz and above. Top surface predicted temperature, Tₜₒₚ is found to generally function as a simple proxy for the formation of PG, while deviations between predicted and actual LLG mostly result from bottom surface predicted temperatures, T_{btm}. The results of the experiments are overlaid with the theoretical predictions in FIGS. 8A and 8B, where the predicted LLG regimes 604, 606, 608, 614, 616, 618 (regions between dark dashed line 604b, 606b, 608b, 614b, 616b, 618b and light dashed line 604i, 606i, 608i, 614i, 616i, 618i) versus actual LLG regime (dotted regions 605, 607, 609, 615, 617, 619) can be compared. The predicted LLG regimes across these parameters are depicted in FIGS. 8A to 8E.

The actual LLG regime deviates from the predicted LLG regime in a few ways which does not however, affect the overall utility of the model. At the bottom surface of the PI tape, the model generally overpredicts T_{btm}, especially when LPG is irradiated by large numbers of low F pulses. This overprediction is probably a result of differing interactions between high and low intensity femtosecond pulses and the complex networked morphology of the LPG, reducing the temperature induced at the bottom surface more at lower F. This difference is not captured in the model, where material changes are based on the assumption that the mechanisms of laser-material interactions do not change depending on F, f or N. Photochemical changes to LPG at lower F which might be superseded by photothermal effects at higher F cannot be ruled out either, However, despite this overprediction of T_{btm}, a clear LLG regime is still identifiable within the predicted parameters, therefore, this deviation does not invalidate the usefulness of the model in predicting the formation of LPG.

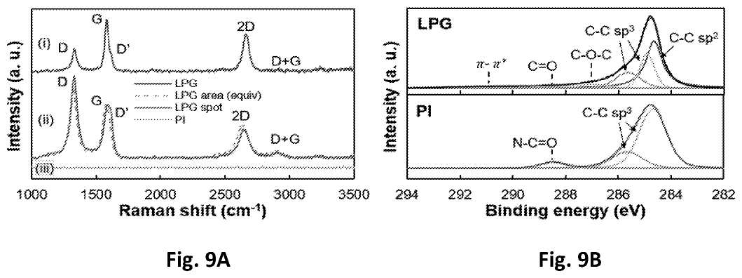

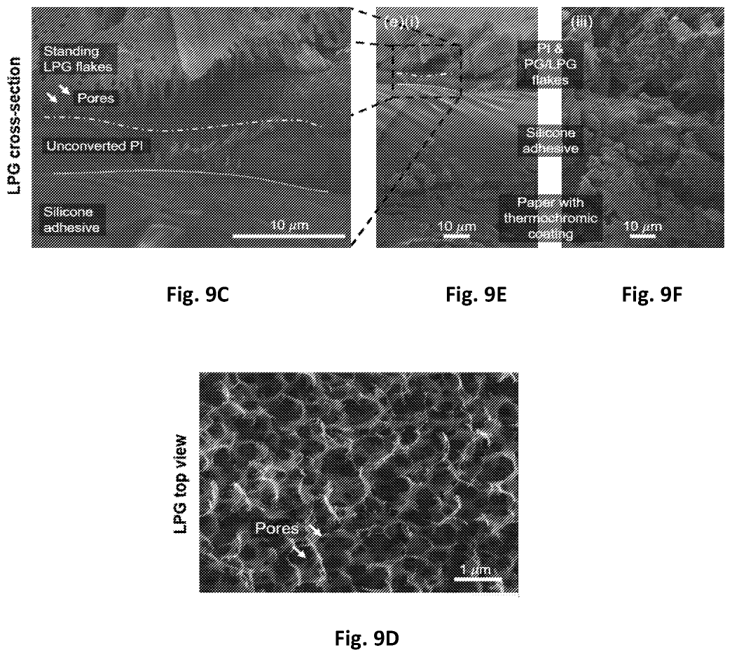

The second notable deviation is observed between the induced discoloration of thermochromic paper from spot irradiation and the equivalent scanning parameters. When large areas of LPG are written with equivalent scanning parameters, only a limited set of parameters with lower N and F (and therefore a lower predicted temperature) do not induce discolouration to the thermochromic paper (FIGS. 8A and 8B, dotted regions 605, 607, 609, 615, 617, 619) than otherwise predicted by the model. This discrepancy can be attributed to the differences in temperature profiles when comparing spot irradiation versus scanning. During spot irradiation, all incident pulses fall onto the same area, therefore changes to material properties such as thermal conductivity can be predicted by the model relatively accurately. During the scanning process however, overlapping lines and pulses would lead to exposure to different effective material properties per pulse, leading to a much more uniform temperature profile than otherwise predicted. Other differences could arise from the writing process itself, with additional deviations due to changes in acceleration and speed at corners or at the beginning of lines, or other artifacts from galvanoscanner scanning that are not considered. Despite these deviations, PG formed from spot and equivalent scanning parameters (FIG. 9A(ii)) still show similar Raman peak intensities and positions, the main difference being a downshift of peak positions with scanned parameters (˜16 cm⁻¹). Therefore, scanned writing parameters that fulfil conditions for LLG can still be found within the LLG regime. Other scanning strategies such as dot (raster) strategies could also help to mitigate this issue.

In summary, experimental verification shows that the developed temperature model functions as a useful benchmark for identifying the LLG regime and therefore optimal parameters for the formation of LPG. This benchmark works despite underpredicting LPG formation at lower F and higher N, and overpredicting LPG formation when scanned versus spot irradiation.

### Example 3

Various mechanisms and process that lead up to the formation of LPG in the LLG regime can be proposed from the results of the validation studies. As discussed previously, besides the LLG regime three other regimes can also be identified. In the first two regimes, top surface temperatures do not exceed T_{grphtn} (i.e. no LPG or HPG formation predicted).

However, while heating at the bottom surface is kept below 348K for the low temperature (LT) regime, heating at the bottom surface exceeds 348K for an extended low temperature (ELT) regime. The third is a high temperature (HT) regime where HPG formation is predicted along with excessive heating above T_{dmg} at the bottom surface of PI is predicted.

These four temperature regimes are defined by temperature profiles induced by the three laser parameters under investigation: repetition rate (f), fluence (F) and number of pulses (N). Conveniently, the sequential and stepwise nature of the validation experiments allows discernment of the formation mechanisms through each regime.

LPG formation begins with accumulation of heat above the threshold fluence for ablation in the low temperature (LT) regime (FIG. 8C, 802). Beginning with a single pulse at the lowest investigated fluence (0.0233 Jcm⁻²) ablation of the PI surface is observed at low f, F and N without any carbonisation or graphitisation at the top surface of the PI, or any coloration of the thermochromic paper at the bottom surface. Raman spectroscopy confirms the lack of carbonaceous material formed, showing none of the peaks (D, G or 2D) associated with PG (FIG. 8D(iv)). Ablation of the PI surface is expected as the minimum fluence investigated (0.023 Jcm⁻²) falls within typically reported ranges for femtosecond laser ablation of PI. At and above this threshold fluence, a combination of thermal and a thermal processes leads to bond breaking and subsequent violent ejection of material of the PI. As ablation is partially a thermal process, some amount of thermal energy is left over within the unablated PI and can be accumulated with subsequent pulses. As f, F and N steadily increases, more heat is accumulated within the surface. f heavily influences the accumulation of thermal energy, as each individual pulse interacts with the material at timescales (fs) far shorter than that of thermal diffusion/conduction away from the local pulse interaction region (μs) in dielectrics and polymers. This effect leads to f playing an outsized regulatory role compared to F or N. At low f (<5 kHz) in particular, the PI cools significantly between pulses because of the μs duration between pulses. Still within the LT regime but at higher f (>100 kHz) with low F or N, no significant carbonisation takes place either because of a lack of energy or sufficient pulses for heat accumulation respectively, although some signs of UV-induced darkening in ablation craters are observed. Limited heating at the surface translates to a lack of heating at the bottom of the thermochromic paper below, due to the low thermal conductivity of polyimide even at 858K. Correspondingly, no colouring is observed on thermochromic paper below at this first step. Only a minimal amount of heating can be accumulated, leading to the dominance of ablation and low predicted temperatures at Tₜₒₚ.

As f, F and N increases within the LT regime, the steady accumulation of heat leads to carbonisation of PI to form an inferior amorphous carbon (a-C) (FIG. 8C, 804) beginning from 858 K. Raman spectroscopic analysis of the irradiated spots reveal the presence of two peaks at 1331 cm⁻¹ and 1582 cm⁻¹ that correspond to D and G peaks, with a distinct lack of a 2D peak around 2650 cm⁻¹ (FIG. 8D(iii)) The carbonaceous material can be identified as an inferior a-C instead, similar to those formed under isothermal heating of Kapton. While conductive, the amorphous carbon is not of interest in for this work because of its overall poorer electrical properties and sensing properties, which are essential for efficient electronic devices. Carbonisation marks the shift from away from ablation as discussed previously, having an outsized effect on heating, as the threshold ablation fluence for a-C is much higher than the range of F under investigation. Carbonisation is driven by the increase in heat accumulation, as mechanisms for graphitisation and carbonisation of PI with UV lasers are reported to be thermally driven. With increased f, the time period between pulses (τ_{L}) reduces, and more heat is accumulated within the irradiated region with each pulse for the same N or F. The combination of photochemical and photothermal effects lead to the decomposition of imide and aliphatic groups, followed by the release of volatiles and other gases such as CO and O₂, as PI is steadily converted into a-C. Accumulation of these gases below the immediate surface of the PI and carbonaceous material formed also lead to an observed ballooning of the irradiated area in line with other reports.

At the bottom surface of the adhesive, two distinct phenomena can be observed in the LT regime. In the first case, where f=250-500 kHz, heating is rapidly localised at the surface such that carbonisation can occur without thermal damage to the substrate below i.e. no observed colouration of the thermochromic paper. Localisation occurs when the rate of heating at the top surface exceed the rate of diffusion. At high f, the thermal diffusion length L_{D} is reduced according to the relation L_{D}=\sqrt{D/f}. Since a shorter L_{D} results in a shorter distance where heating is reduced by e times, heat is better localised at higher f. This same effect also plays a role in the formation of LPG at higher surface temperatures. a-C formation also plays a role on limiting heat diffusion at high f. Despite being a carbonanceous material, a-C has a very low thermal conductivity K similar to PI at 858K. With the low κ of a-C, heating is still localised to the top surface. Lateral diffusion dominates over axial diffusion, and minimal heating below T_{dmg} is induced at the bottom surface of the adhesive through throughout exposure at high f. is expected for an intermediate state of LPG, where a-C would be formed before LPG. However, at lower f (100 kHz), a second phenomenon is observed where carbonisation at the top surface (forming a-C) is followed with extensive heating at the bottom surface, resulting in a more uniform heating distribution typical of conventional PG formation with long pulse or CO₂ lasers. This phenomenon is driven by the longer amount of time heating for the same amount of pulses. As less energy is accumulated per pulse, PI would be converted to a-C across a longer period of time, and subsequently kept at elevated temperatures for longer (up to 5 times longer compared to 500 kHz), which would be sufficient time for heat from the surface to diffuse more evenly throughout the depth of the PI tape. The longer L_{D} at 100 kHz (compared to 250 kHz or 500 kHz) also plays a role in increasing thermal diffusion. This description is supported by the significantly more diffuse patterns of heating in thermochromic paper which increases in width as N increases, indicating that heat has had significant time to diffuse through the material. This regime is this approximately termed the extended low temperature (ELT) regime. More rapid heating in contrast, would cause sharper patterns to form on the thermochromic paper at the high temperature (HT) regime. The presence of these two phenomena showcases the importance of rapid localised heating for LLG, especially in such a thin (˜100 μm) region of interest.

Within the LLG regime, sharply increased localised heating with each pulse at high f (≤250 kHz) drives graphitisation of the a-C (FIG. 8C, 806). Graphitisation proceeds through the growth and clustering of carbon sp² clusters from the sp³ matrix of the a-C, possibly through available benzene rings, leading to the formation of a distinct 2D peak in the LPG Raman spectrum (FIG. 8D(ii)). Remaining oxygen and nitrogen-containing groups in PI surrounding the a-C (along with gases trapped from the formation of a-C) are forcibly and explosively removed, leading to the formation of an open, porous structure of highly disordered and defect heavy graphene flakes, in contrast to the more orderly and defect-free formation of monolayer or multi-layered graphene. As discussed previously, T_{grphtn} is a good predictor for LPG formation. Changes to LPG do not stop at T_{grphtn} however, further increases in temperature above T_{grphtn} leads to further graphitisation of LPG, as measured by a decrease in the I_{G}/I_{2D} ratio (FIG. 8E). The electrical performance of LPG increases as I_{G}/I_{2D} approaches the ideal ratio for mono-layer graphene (0.25). The increase in temperature above T_{grphtn} is driven by direct absorption of UV fs pulses as graphene is highly absorptive in the UV spectrum. By quickly heating the surface of the PI at high f such that energy is only contained in at the surface of PI to drive graphitisation only at the top surface of the PI tape while axial diffusion is restrained with minimal diffusion to the rest of the PI.

This increase in graphitisation comes at the cost of induced damage at the bottom surface of the PI tape. With the formation of LPG, κ is expected to drastically increase, by up to three times (from similar PG materials) and is taken to be 0.7 W m⁻¹ K¹ for the model, as described previously. This increase in K would subsequently alter the balance between heat accumulation at the surface and heat diffusion through the PI tape. Increased axial diffusion would eventually lead to T_{btm} exceeding T_{dmg} at the bottom of the PI tape, which would mark the start of the HT regime. This increase in K, coupled with increased exposure time and longer L_{D} at lower f explains why no LLG regime is observed at 50 kHz, despite lower surface temperatures. PG is formed instead, through similar mechanisms but with T_{btm} exceeding T_{dmg}. The main compromise for LPG is therefore a reduced degree of graphitisation (compared to PG formed in the high temperature regime) for a lack of induced damage at the bottom surface.

The HT regime is generally the regime in which most reports of PG formation (FIG. 8C, 808) would fall under, although this definition can change depending on how T_{dmg} is defined. The HT regime is marked by T_{btm} exceeding T_{dmg}, while the I_{G}/I_{2D} ratio of PG continues to increase with increasing Tₜₒₚ (FIGS. 8D(i) and 8E).

### Example 4

LPG formation and induced thermal damage are validated simultaneously. PI tape is adhered firmly on thermochromic paper, such that the thermochromic coating faces towards the PI layer. Femtosecond pulses are then focused onto the surface of the PI tape using a THG (343 nm) fs laser galvanoscanner set-up to modify the PI across different spots, each with different fluence (F), repetition rates (f) and number of pulses (N). f is considered in a range of 50 to 500 kHz, N from 1 to 5,000, and F from 0.023 Jcm⁻² to 0.068 Jcm⁻². Each set of parameters are repeated thrice, together forming an array of written spots on the PI tape above the thermochromic paper. In order to study (any) material changes such as the formation of LPG at the irradiated spots, Raman spectroscopy is employed.

Determination of thermal damage is achieved by checking the thermochromic paper layer for (dis)colouration after irradiation. The PI film is gently separated from the thermochromic paper substrate, without damaging thermochromic coating below. Any colouration of the thermochromic coating below the irradiated spots (which would lend evidence to heating of the paper substrate) is then examined under a laser confocal microscope for analysis. The results from the predicted and actual LLG regimes can then be compared and analysed.

To verify whether these same LPG parameters can be used to form arbitrarily shaped LPG devices, these LPG spot parameters are translated into equivalent scanning parameters. The number of pulses N, incident across the width of the beam is converted to an equivalent scan speed for the galvanoscanner depending on f. f and F does not change. 2D shapes are then formed by applying a line overlap of 50%. With these parameters, 2×5 mm rectangles of LPG are written on PI film adhered to thermochromic paper for further material characterisation. Raman spectra are obtained again to compare written to spot results. Field emission scanning electron microscopy (FESEM) is used to investigate the detailed morphology and cross-section of the LPG, while x-ray photoelectron spectra (XPS) are used to obtain further insights into the formation of LPG.

### Example 5

Arbitrarily shaped areas of highly graphitised LPG is shown to form within an experimentally verified LLG regime. Both conditions for LPG formation are met in this regime and validated sequentially; PG is first identified at the top surface of PI tape, before confirming that no thermal damage is observed at the thermochromic paper surface.

Raman spectroscopic analysis of LPG (FIG. 9A(i)) reveals spectra consisting of three distinct peaks. Two of the peaks from the spot LPG spectra are the D and tell-tale 2D peaks at 1333 cm⁻¹ and 2663 cm⁻¹, while the second peak is a convolution of two smaller peaks; the G peak at 1582 cm⁻¹ and a less pronounced defect driven D′ peak at 1616 cm⁻¹. Each of these peaks can be fitted with a single Lorentzian curve. The relative intensity ratios of the peaks are I_{D}/I_{G}=0.52 and I_{G}/I_{2D}=0.84. Raman spectra from LPG formed with different parameters (both spot and scanned) within the same LLG regime in comparison (FIG. 9A(ii)), also reveals a similar set of peaks at similar positions (with an additional D+G peak at 2984 cm⁻¹), but with differing relative peak intensities (are I_{D}/I_{G}=1.76 and I_{G}/I_{2D}=1.05). The G peak arises due to vibrations (stretching) from sp₂ (flat) sites in carbon allotropes, while the D, D′ and D+G peaks arise from defect driven phonon scattering in the PG structure. Out of all of the other peaks, the presence of the intense 2D peak (relative to the G peak) that which originates from scattering by second order zone-boundary phonons supports the conclusion that the material identified is PG. Furthermore, all three PG spectra have 2D peak FWHMs approximately double than that of the G peaks, indicating that PG generally consists of turbostratic or disordered graphene layers (without AB stacking). These results and conclusions fall in line with other reported Raman spectra of PG formation. As a reference, virgin PI lacks any peaks in the same spectral region (FIG. 9A(iii)). None of the PG formed with these parameters (within the experimentally verified LLG regime) induce discolouration of the thermochromic coating below the PI layer, verifying that LPG (instead of HPG) is formed.

The quality of the PG formed can however differ depending on parameters used. LPG formed at higher predicted temperatures tend to have fewer defects. By comparing the relative intensities and the full-width-half-maximums (FWHM) of the fitted peaks, the LPG can be further characterised. A low degree of disorder (and number of defects) and larger crystallite sizes (Lₐ), according to the Tuinstra-Koenig relation (I_{D}/I_{G}∝1/Lₐ) are characterised by low I_{D}/I_{G} ratios, while a high degree of graphitisation is indicated by a low I_{G}/I_{2D} ratio. Therefore, the LPG formed at higher predicted temperatures are more highly graphitised (I_{G}/I_{2D}=0.84 vs 1.05), with a much lower degree of disorder and larger crystallites (I_{D}/I_{G}=0.52 vs 1.76) compared to LPG formed at lower predicted temperatures. The lack of a D+G peak with the LPG formed at higher predicted temperatures also supports this conclusion.

Further investigation of scanned LPG under x-ray photon spectroscopy (XPS) reveals that LPG formation leads to a drastic reduction in atomic percentage of N and O from 21.3% to 4.7% and a corresponding increase in C from 78.7 to 95.3%. A comparison of the C1s curves of LPG and PI (FIG. 9B) reveals other changes in chemical structure from PI to LPG. Further evidence of the formation of graphene can be found from the deconvoluted asymmetric sp² peak centered around 284.5 eV previously missing in PI, and a small satellite peak at 290.5 eV that indicates the presence of π-π* transitions due to sp² hybridisation. Conversely, other components such as C═O and the C—C sp³ component at 285.6 eV that are identified in PI are highly suppressed in LPG. Together, evidence from XPS supports the overall picture of carbonisation and graphitisation following the removal of N and O containing groups through the formation of LPG.

The morphological arrangement of scanned LPG, suitable for devices is unveiled under FESEM (FIG. 9C). A clear layered arrangement can be observed, where the porous and networked LPG structure is localised near the surface of the PI, such that only LPG is converted from a minimally thick (˜10 μm) layer of PI. This thickness includes material removed from ablation, therefore the depth of PI converted is deeper than otherwise expected with similar reports using UV lasers. Despite a greater amount of PI removal, a significant amount of PI (5-7 μm) is still left unconverted to function as mechanical support for the LPG flakes, and no significant changes to the silicone adhesive layer can be observed directly. Higher magnification FESEM images of the top surface of LPG (FIG. 9D) reveals a different angle of the highly disordered and porous network of standing LPG flakes. Together, both cross section and top view images support an overall picture of a material with a large 3D active surface area, important for high performance MSCs and sensor devices.

In FIG. 9E, the same area from FIG. 9C is imaged, but at a lower magnification. At this magnification, differences between LPG and HPG formation can be deduced. All the distinct layers from LPG to the thermochromic paper do not show any visual evidence of damage. The formation of HPG (FIG. 9F) in contrast reveals a fully carbonised PI layer, as well as burnt silicone adhesive that extends all the way down to the thermochromic paper. The top view of LPG and HPG sensors fabricated on thermochromic paper support the same depiction (FIG. 1D). As deduced from the FESEM cross section of LPG, no discoloration of the thermochromic paper is observed below the LPG sensor (FIG. 1E), a result of insufficient heating of the solvent/leuco dye mixture within the thermochromic paper. Extensive heating evidenced from the deep colouring of the thermochromic paper is observed below the HPG sensor fabricated in the high temperature regime. Heating can therefore be localised at the surface to form LPG within the LLG regime. Altogether, a picture of the LLG emerges where highly graphitised LPG is formed in-situ without thermal damage to the paper substrate for high performance integrated graphene-paper devices.

### Example 6

With deeper understanding of the material properties and mechanisms of formation of LPG, LPG can then be directly fabricated and integrated onto paper substrates. An example of a paper device with an integrated LPG sensor and MSc is shown in FIG. 6. The next step is then to investigate the performance of these LPG devices. Two devices, a LPG MSC and a LPG humidity sensor are fabricated and characterised individually.

A key limitation of current paper electronics is the lack of integrated site-specific energy sources. While current collectors and MSC materials can be directly deposited onto paper substrates, MSCs commonly require the use of a gel or liquid-type electrolyte to enable pseudo-capacitance. Such electrolytes however tend to be absorbed and diffused through hygroscopic cellulose. While some paper MSC out-of-plane designs do utilise this property (with the paper functioning as a separator), diffusion can lead to electrical shorts across in-plane MSC, or the degradation of the paper substrate below the MSC. Other alternatives either rely on expensive or untested methods to treat the paper to allow for paper to take electrolyte, or use less recyclable alternatives such as photo paper, which has a water impermeable layer added to reduce diffusion into the cellulose. PI on the other hand is low cost, commercially available, does not affect the re-processability of paper, and is much more chemically resistant to most common electrolytes. From the FESEM images of LPG discussed previously, the unconverted PI layer below the LPG acts as a barrier, preventing the ionic liquid electrolyte from coming into contact with the paper substrate below. Therefore electrolyte can be directly deposited on the LPG MSC forming a site-specific energy source that can be designed to fit the device' performance as required.

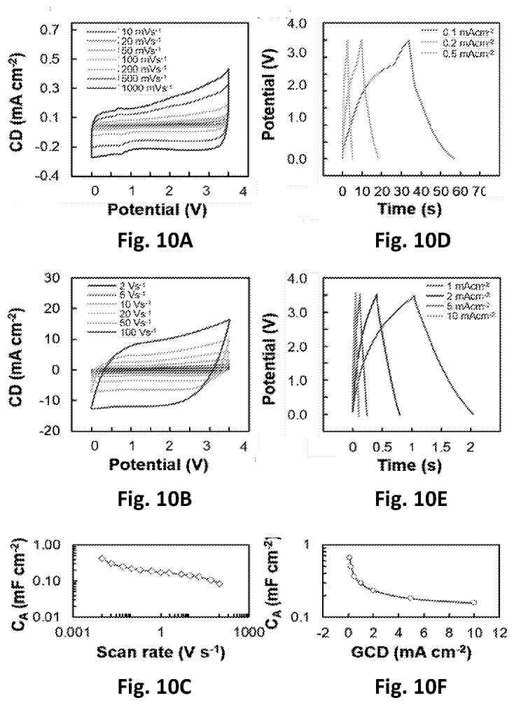

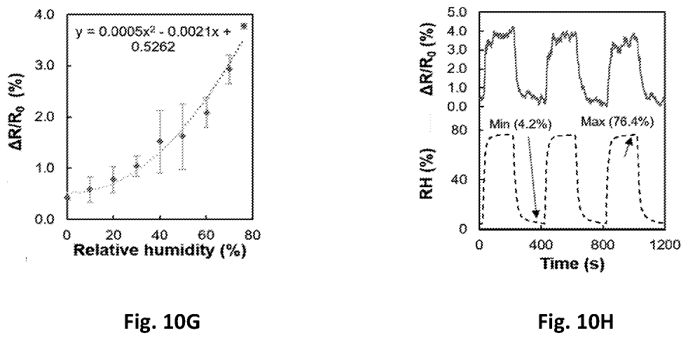

The performance of LPG MSCs directly fabricated via LLG over paper are investigated. To demonstrate the use of an electrolyte that would not otherwise be directly compatible with paper as well as expand the potential window and current density, an ionic liquid electrolyte, 1-ethyl-3-methylimidazolium tetrafluoroborate (EMIMBF4) is used. The electrochemical performances of the LPG MSC were investigated by cyclic voltammetry (CV) and galvanostatic charge discharge (GCD) measurements, and areal capacitances (C_{A}) were calculated based on the CV and GCD results. CV curves at scan rates ranging from 10 mV s⁻¹ to 100 V s⁻¹ are shown in FIGS. 10A and 10B. The CV profiles have rectangular shapes, showcasing the high capacitive performance of LPG even at high scan rates of 100 V s⁻¹. This capacitive performance likely results from the large active surface area of the highly porous LPG flakes. The calculated C_{A} by the CV measurement is shown in FIG. 10C. The C_{A} were 0.428, 0.221, 0.174, and 0.141 mF cm⁻² at scan rate of 10, 100, 1,000, and 10,000 mV s⁻¹ scan rate respectively, similar in performance to other reported PG MSCs from PI. GCD results are shown in FIGS. 10D and 10E at various discharge current densities from 0.1 mA cm⁻² to 10 mA cm⁻². C_{A} based on the GCD results were also calculated (FIG. 10F). C_{A} values based on the GCD results (FIG. 10B) shows similar values and trend for the discharge current density with the C_{A} based on the CV results. In summary, these electrochemical results demonstrate that LPG MSCs can be used as site specific power sources for high performance self-powered graphene-paper electronics.

LPG from PI also solves another key limitation of paper electronics in the measurement of relative humidity (RH). Paper is hygroscopic, and exposure to high humidity levels across long periods of time will cause irreversible damage. PI in contrast, is impervious to water damage, therefore by integrating LPG humidity sensors with paper electronics, a simple, low cost resistive humidity sensor can be demonstrated. Humidity sensing is achieved without the need for additional hygroscopic elements.

The response of LPG to increasing humidity is first investigated. Actual humidity (and temperature) values are obtained from a commercial humidity sensor placed in parallel to the LPG sensor, with responses recorded every two seconds. The resistance across the LPG sensor is found to increase by up to 4% in a generally parabolic matter as RH is increased from 0.0% to 76.4% (FIG. 10G). As established previously, LPG is made up primarily of smaller crystallites of graphene, due to the high I_{D}/I_{G} ratio. These crystallites result in a large amount of graphene grain boundaries, which act as active water absorption sites. Water absorption from an increase in RH would then leads to a local decrease in resistivity due to reduced charge carrier transport. While grain adsorption dominates for LPG, the high density of defects in LPG (intense D and D′ peaks) would also result in a large role for a competing mechanism for water adsorption on graphene at edge defects. Water adsorption at edge defects results in decreased resistance instead, as ionic conductive chains are formed with increasing RH. The interplay of these two mechanisms most likely contribute to the large amount of variation in recorded measurements, especially at 40 to 50% RH.

The cyclic performance of the LPG sensor is measured next to investigate the repeatability of RH sensing. RH within the chamber is cycled repeatedly between maximum and minimum RH every 200 seconds, resulting in a minimum and maximum of 4.6% and 76.4% RH. The measured curves are plotted in FIG. 10H with reference sensor data for comparison. LPG responds quickly to large and rapid increases and decreases in humidity, reaching saturation at maximum humidity. This value however, does not indicate the maximum possible range of the LPG humidity sensor, as this maximum value is due to the limitations of the lab-built system. Adsorption and desorption of water molecules from LPG occurs quickly enough that the same minimum can be reached with each cycle. A drawback of the current LPG sensor, unfortunately is the undesired noisiness of the data, probably arising from the interplay of competing mechanisms discussed previously. Improvements could come about with further optimisation within the LLG regime to reduce the density of edge defects, or the addition of hygroscopic materials directly onto the LPG. Despite this drawback, LPG still demonstrates satisfactory performance as a humidity sensor, with no additional complexity in fabrication. This simplicity allows the sensor for easy integration with paper electronics, possibly in combination with the previously demonstrated LPG MSCs to realise standalone graphene-paper electronics.

1. A method for manufacturing a porous graphene layer across a precursor material layer on a substrate, the method comprising:
determining a first temperature threshold and a second temperature threshold, the first temperature threshold being a minimum temperature required for forming the porous graphene layer from a precursor material layer on a portion of the substrate, the second temperature threshold being one at which the substrate is likely to experience thermal damages above this temperature threshold;
determining at least one of operating parameters of a light source, wherein exposing the precursor material layer to the light source that is operating under the at least one of the operating parameters causes a temperature of the portion of the substrate adjoining a side of the precursor material layer to maintain below the second temperature threshold and a temperature of the opposite side of the precursor material layer to rise above the first temperature threshold; and
generating a beam of light from the light source to the precursor material layer based on the at least one of operating parameters of the light source to form the porous graphene layer.

2. The method according to claim 1 further comprising:
generating a temperature profile across the precursor material layer based on at least one parameter of the precursor material layer and at least one of operating parameters of the light source, the temperature profile showing a corresponding temperature for each of a plurality of regions on the precursor material layer including the side of the precursor material layer and the opposite side of the precursor material, wherein the determination of the at least one of operating parameters of the light source is based on the temperature profile.

3. The method according to claim 2, wherein the at least one parameter of the precursor material layer is at least one of a thickness, an absorption coefficient, a reflectivity, a density, a specific heat capacity, a thermal conductivity and a thermal diffusivity.

4. The method according to claim 1, wherein the at least one of operating parameters of a control system, the control system being at least the light source which comprises at least one of an incident fluence, a repetition rate, a number of pulses, a pulse width, a polarization, a wavelength, an average power, an energy intensity and a lens orientation of the light source.

5. The method according to claim 4, wherein the beam of light is continuous.

6. The method according to claim 4, wherein the beam of light is intermittent, and the pulse width of the beam of light is an ultrafast pulse width in a range of femtoseconds or picoseconds.

7. The method according to claim 4, wherein the wavelength of light source is in a range of an ultraviolet light wavelength, a visible light wavelength, an infrared light wavelength or a combination thereof.

8. The method according to claim 1, wherein the determination of the first temperature threshold and the second temperature threshold is based on empirical data of exposing the precursor material and the substrate respectively to the light source that is operating under one or more operating parameter(s) different from the at least one of operating parameters.

9. The method according to claim 1, wherein the precursor material is made of a carbon containing material such as synthetic or organic polymer.

10. The method according to claim 1, wherein the substrate is made of a material or a combination of materials that has at least one of a melting temperature, a glass temperature or a decomposition temperature close to or lower than the second temperature threshold.

11. An apparatus for manufacturing a porous graphene layer across a precursor material layer on a substrate, the apparatus comprising:
at least one processor; and
at least one memory including computer program code;
the at least one memory and the computer program code configured to, with at least one processor, cause the apparatus at least to:
determine a first temperature threshold and a second temperature threshold, the first temperature threshold being a minimum temperature required for a precursor material layer on a portion of the substrate to form the porous graphene layer, the second temperature threshold being one at which the substrate is likely to experience thermal damages above this temperature threshold;
determine at least one of operating parameters of a light source, wherein exposing the precursor material layer to the light source that is operating under the at least one of the operating parameters cause a temperature of the portion of the substrate adjoining a side of the precursor material layer to maintain below the second temperature threshold and a temperature of the opposite side of the precursor layer to rise above the first temperature threshold; and
generate a beam of light from the light source to the precursor material layer based on the at least one of operating parameters of the light source to form the porous graphene layer.

12. The apparatus according to claim 11, wherein the at least one memory and the computer program code is further configured with the at least one processor to:
generate a temperature profile across the precursor material layer based on at least one parameter of the precursor material layer and at least one of operating parameters of the light source, the temperature profile showing a corresponding temperature for each of a plurality of regions on the precursor material layer including the side of the precursor material layer and the opposite side of the precursor material, wherein the determination of the at least one of operating parameters of the light source is based on the temperature profile.

13. The apparatus according to claim 12, wherein the at least one parameter of the precursor material layer is at least one of a thickness, an absorption coefficient, a reflectivity, a density, a specific heat capacity, a thermal conductivity and a thermal diffusivity.

14. The apparatus according to claim 11, wherein the at least one memory and the computer program code is further configured with the at least one processor to:
control the at least one of operating parameters of a control system, the control system being at least the light source, which comprises at least one of an incident fluence, a repetition rate, a number of pulses, a pulse width, a polarization, a wavelength an average power, an energy intensity and a lens orientation of the light source.

15. The apparatus according to claim 14, wherein the beam of light is continuous.

16. The apparatus according to claim 14, wherein the beam of light is intermittent, and the pulse width of the beam of light is an ultrafast pulse width in a range of femtoseconds or picoseconds.

17. The apparatus according to claim 14, wherein the wavelength of light source is in a range of an ultraviolet light wavelength, a visible light wavelength, an infrared light wavelength or a combination thereof.

18. The apparatus according too claim 11, the at least one memory and the computer program code is configured to:
determine the first temperature threshold and the second temperature threshold based on empirical data of exposing the precursor material and the substrate respectively to the light source that is operating under one or more operating parameter(s) different from the at least one of operating parameters.

19. The apparatus according to claim 11, wherein the precursor material is made of a carbon-containing material such as synthetic or organic polymer.

20. The apparatus according to claim 11, wherein the substrate is made of a material that or a combination of materials that has at least one of a melting temperature, a glass temperature or a decomposition temperature close to or lower than the second temperature threshold.

21. An electronic device comprising at least one porous graphene layer across a precursor material layer on a substrate, wherein the at least one porous graphene layer is manufactured according to a method, the method comprising:
determining a first temperature threshold and a second temperature threshold, the first temperature threshold being a minimum temperature required for forming the porous graphene layer from a precursor material layer on a portion of the substrate, the second temperature threshold being one at which the substrate is likely to experience thermal damages above this temperature threshold;
determining at least one of operating parameters of a light source, wherein exposing the precursor material layer to the light source that is operating under the at least one of the operating parameters causes a temperature of the portion of the substrate adjoining a side of the precursor material layer to maintain below the second temperature threshold and a temperature of the opposite side of the precursor material layer to rise above the first temperature threshold; and
generating a beam of light from the light source to the precursor material layer based on the at least one of operating parameters of the light source to form the porous graphene layer.

22. (canceled)
